(19) United States
(12) Patent Application Publication
(10) Pub. No.: US 2015/0302612 A1
(43) Pub. Date: Oct. 22, 2015

(54) IMAGE-RENDERING DEVICE, IMAGE-RENDERING METHOD, AND NAVIGATION DEVICE

(71) Applicant: MITSUBISHI ELECTRIC CORPORATION, Chiyoda-ku, Tokyo (JP)

(72) Inventors: Kotoyu ISHIKAWA, Tokyo (JP); Ken MIYAMOTO, Tokyo (JP); Shoichiro KUBOYAMA, Tokyo (JP); Makoto OTSURU, Tokyo (JP); Hiroyasu NEGISHI, Tokyo (JP)

(73) Assignee: Mitsubishi Electric Corporation, Chiyoda-ku, Tokyo (JP)

(21) Appl. No.: 14/437,380

(22) PCT Filed: Jun. 18, 2013
(86) PCT No.: PCT/JP2013/003782

§ 371 Date: Apr. 21, 2015

(30) Foreign Application Priority Data
Oct. 24, 2012 (JP) 2012-234373

(51) Int. Cl. G06T 11/00; G06T 7/00

(52) U.S. Cl. CPC G06T 11/001; G06T 7/0081; G06T 2207/10024

(57) ABSTRACT

An image-rendering device: divides a large region whose minimum configuration unit is an element into small regions each configured with the elements; calculates low resolution distance data showing a distance from a base line serving as a reference for color change in gradation for each of the small regions; associates low resolution distance data showing each distance from the base line for each of the small regions with high resolution distance data showing each distance from the base line to each of the elements, and stores them in high resolution data storage; obtains, from the high resolution data storage, the high resolution distance data associated with the calculated low resolution distance data; and renders gradation on the basis of the high resolution distance data. Therefore, it is possible to reduce the number of times for calculating a minimum distance between the base line and each pixel.

### TECHNICAL FIELD

The present invention relates to a device for rendering gradation at high speed.

### BACKGROUND ART

When an image on a computer is colored, gradation is employed in which brightness and color are continuously changed. For example, color of each pixel is changed in accordance with a distance from one of sides that surround a graphic, and red is assigned to a pixel having a small distance from the side, blue to a pixel having a large distance, and purple to a pixel having a middle distance. By coloring in such a manner, gradation of changing from red to purple and purple to blue can be obtained.

A technology is presented in which gradation is rendered on a computer at the inside of a closed region surrounded by two or more base lines. A minimum distance from the base line is calculated for each of all pixels in the closed region, and color to be set for each pixel is determined on the basis of color characteristics of the base line, the minimum distance, and a distance function (see Patent Document 1 below).

### PRIOR ART DOCUMENTS

### Patent Documents

Patent Document 1: Japanese Unexamined Patent Application Publication No. 2010-165058

### SUMMARY OF THE INVENTION

### Problem that the Invention is to Solve

In Patent Document 1, a minimum distance from a base line is calculated for each of all pixels at the inside of a closed region where gradation is desired to be rendered. When the region where gradation is desired to be rendered is large, the number of pixels for which color is set is large and there has been a problem that the calculation of minimum distance from base line for all pixels needs time.

The present invention is made to solve the above described problems, and an objective thereof is to obtain an image-rendering device in which the number of times for calculating the minimum distance between the base line and the pixel is reduced.

### Means for Solving the Problem

An image-rendering device in the present invention is characterized in that: a large region whose minimum configuration unit is an element is divided into small regions each configured with the elements; low resolution distance data showing a minimum distance from a base line serving as a reference for color change in gradation is calculated for each of the small regions; low resolution distance data for storing each minimum distance from the base line for each of the small regions is associated with high resolution distance data for storing each minimum distance from the base line for each of the elements and they are stored in a high resolution data store unit; high resolution distance data associated with low resolution distance data, from among the low resolution distance data stored in the high resolution data store unit, which coincides with the low resolution distance data calculated by the low resolution data calculation unit is obtained from the high resolution data store unit; and gradation is rendered on the basis of the high resolution distance data.

The image-rendering device in the present invention is characterized in that: a large region whose minimum configuration unit is an element is divided into small regions each configured with the elements; low resolution distance data showing a minimum distance from a base line serving as a reference for color change in gradation is calculated for each of the small regions; the low resolution distance data is converted into low resolution color value data showing a color value for each of the small regions; low resolution color value data for storing each color value for each of the small regions is associated with high resolution color value data for storing each color value for each of the elements and they are stored in a high resolution data store unit; high resolution color value data associated with low resolution color value data, from among the low resolution color value data stored in the high resolution data store unit, which coincides with the converted low resolution color value data is obtained from the high resolution data store unit; and gradation is rendered on the basis of the obtained high resolution color value data.

The image-rendering device in the present invention is characterized in that: a large region whose minimum configuration unit is an element is divided into small regions each configured with the elements; low resolution distance data showing a minimum distance from a base line serving as a reference for color change in gradation is calculated for each of the small regions; high resolution distance data showing a minimum distance from the base line is calculated, from the calculated low resolution distance data, for each of the elements by employing algorithm; the high resolution distance data is converted into high resolution color value data for storing a color value of each of the elements; and gradation is rendered on the basis of the converted high resolution color value data.

The image-rendering device in the present invention is characterized in that: from low resolution distance data showing a minimum distance from a base line serving as a reference for color change in gradation for small regions each of which has elements each being a minimum configuration unit, high resolution distance data showing a minimum distance from the base line for each of the elements is calculated by employing algorithm; and an alpha channel value is calculated on the basis of the high resolution distance data, and an image is rendered in which a foreground image and a background image are alpha-blended.

A navigation device in the present invention is characterized in that: a route is searched on the basis of a current vehicle position, a destination, and a map database; a base line serving as a reference for color change in gradation and a map image are outputted on the basis of the route and the map database; a large region whose minimum configuration unit is an element is divided into small regions each configured with the elements; low resolution distance data showing a minimum distance from the base line is calculated for each of the small regions; low resolution distance data for storing each minimum distance from the base line for each of the small regions is associated with high resolution distance data for storing each minimum distance from the base line for each of the elements, and they are stored in a high resolution data store unit; high resolution distance data associated with low resolution distance data, from among the low resolution distance data stored in the high resolution data store unit, which coincides with the calculated low resolution distance data is obtained from the high resolution data store unit; and an alpha channel value is calculated on the basis of the high resolution distance data, and an image is rendered in which the map image and a background image are alpha-blended.

The navigation device in the present invention is characterized in that: a route is searched on the basis of a current vehicle position, a destination, and a map database; a base line serving as a reference for color change in gradation and a map image is outputted on the basis of the route and the map database; from low resolution distance data showing a minimum distance from the base line serving as the reference for color change in gradation for small regions each of which has elements each being a minimum configuration unit, high resolution distance data showing a minimum distance from the base line for each of the elements is calculated by employing algorithm; and an alpha channel value is calculated on the basis of the high resolution distance data, and an image is rendered in which the map image and a background image are alpha-blended.

### Advantageous Effects of the Invention

According to the present invention, the number of times for calculating a minimum distance between a base line and a pixel can be reduced.

### BRIEF DESCRIPTION OF DRAWINGS

FIG. 1 is a block diagram showing a configuration of an image-rendering device according to Embodiment 1.

FIG. 2 is a diagram showing a base line according to Embodiment 1.

FIG. 3 is a diagram showing division processing in a region division unit according to Embodiment 1.

FIG. 4 is a diagram showing a minimum distance between the base line and a small region according to Embodiment 1.

FIG. 5 is a diagram showing a result of calculating a minimum distance from the base line for each of small regions included in a medium region according to Embodiment 1.

FIG. 6 is a diagram showing data stored in a high resolution data DB according to Embodiment 1.

FIG. 7 is a diagram showing data generated by logically summing pieces of high resolution data according to Embodiment 1.

FIG. 8 is a flow chart showing processing of a matching unit according to Embodiment 1.

FIG. 9 is a diagram showing conversion from high resolution distance data into high resolution color value data according to Embodiment 1.

FIG. 10 is a block diagram showing a configuration of an image-rendering device according to Embodiment 2.

FIG. 11 is a diagram showing conversion from low resolution distance data into low resolution color value data according to Embodiment 2.

FIG. 12 is a diagram showing data stored in a high resolution data DB according to Embodiment 2.

FIG. 13 is a flow chart showing processing of a matching unit according to Embodiment 2.

FIG. 14 is a block diagram showing a configuration of an image-rendering device according to Embodiment 3.

FIG. 15 is a block diagram showing a configuration of an image-rendering device according to Embodiment 4.

FIG. 16 is a block diagram showing a configuration of an image-rendering device according to Embodiment 5.

FIG. 17 is a diagram showing a foreground image and a background image according to Embodiment 5.

FIG. 18 is a diagram showing an image according to Embodiment 5.

FIG. 19 is a block diagram showing a configuration of a principal part of a car navigation device (hereinafter referred to as “car navigation” as needed) according to Embodiment 6.

FIG. 20 is a diagram showing a map image according to Embodiment 6.

FIG. 21 is a diagram showing an output image displayed on a car navigation screen according to Embodiment 6.

FIG. 22 is a diagram showing an output image displayed on a screen of a conventional car navigation device.

FIG. 23 is a block diagram showing a configuration of an image-rendering device according to Embodiment 7.

FIG. 24 is a diagram showing a base point according to Embodiment 7.

FIG. 25 is a diagram showing a minimum distance between the base point and a small region according to Embodiment 7.

FIG. 26 is a block diagram showing a configuration of an image-rendering device according to Embodiment 8.

FIG. 27 is a diagram showing data stored in a high resolution data DB according to Embodiment 8.

### MODE FOR CARRYING OUT THE INVENTION

Hereinafter, embodiments of a bridge and a network system using the bridge according to the present invention will be explained in detail with reference to drawings. Note that the present invention should not be limited to the embodiments.

### Embodiment 1

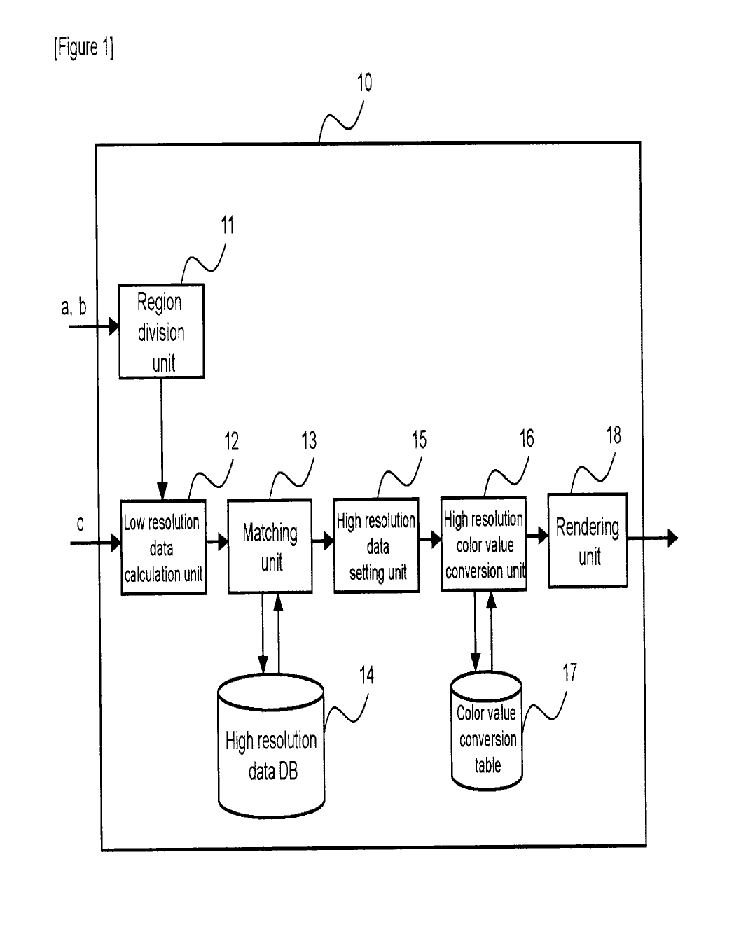

FIG. 1 is a block diagram showing a configuration of an image-rendering device 10 according to Embodiment 1.

Image size information a and division information b of an image rendered by the image-rendering device 10 are inputted to a region division unit 11. The region division unit 11 provides a large region on the basis of the image size information. The region division unit 11 divides the large region into medium regions and further divides the medium region into small regions on the basis of the division information, and outputs them to a low resolution data calculation unit 12. A plurality of elements each serving as a minimum unit for the large region is included in the small region. The region division unit 11 outputs the large region which is divided into the medium regions and small regions to the low resolution data calculation unit 12.

A base line c is inputted to the low resolution data calculation unit 12. The base line is a line serving as a reference for color change in gradation, and is configured with one or more line segments. The low resolution data calculation unit 12 calculates low resolution distance data showing a minimum distance from the base line for each of the small regions, and outputs it to a matching unit 13. The low resolution distance data is associated with high resolution distance data and they are stored in advance in a high resolution data database (hereinafter referred to as high resolution data DB) 14 serving as a high resolution data store unit. The high resolution distance data is data in which a minimum distance from the base line is set for each of the elements.

The matching unit 13 accesses the high resolution data DB 14, conducts search by employing the low resolution distance data inputted from the low resolution data calculation unit 12 as a key, obtains the high resolution distance data, and outputs it to a high resolution data setting unit 15. The high resolution data setting unit 15 sets the high resolution distance data for each of the medium regions in the large region, and outputs it to a high resolution color value conversion unit 16. The high resolution color value conversion unit 16 converts a minimum distance value from the base line set for each of the elements into a color value by referring to a color value conversion table 17, and outputs it a rendering unit 18. The rendering unit 18 renders gradation and outputs it.

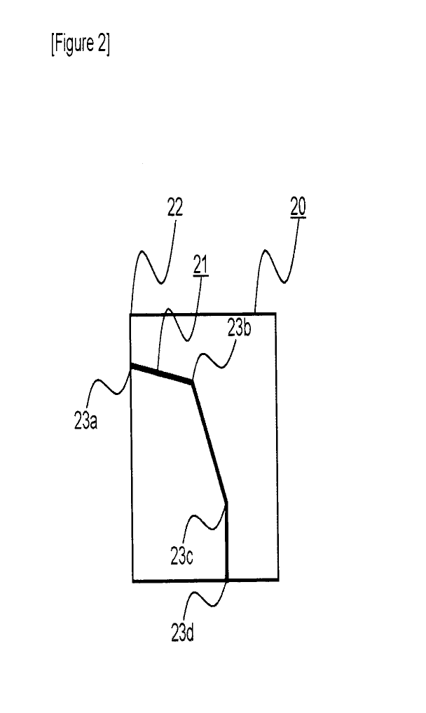

FIG. 2 is a diagram showing a base line 21 according to Embodiment 1. An image 20 is an image including the base line 21. An image size of the image 20 is the same with an image size of an image rendered by the image-rendering device 10. In the image 20, a coordinate of an upper left corner 22 is employed as an origin (0, 0), and the right direction and the lower direction are respectively defined as the +x-axis direction and the +y-axis direction. The base line 21 is a line in which corners 23a through 23d are sequentially connected. Coordinates of the corners 23a through 23c1 are (0, 45), (75, 50), (125, 125), and (125, 200), respectively. In that case, the base line 21 is expressed as (x, y)={(0, 25), (75, 50), (125, 125), (125, 200)}.

While the base line 21 is expressed by an absolute coordinate in FIG. 2, a data format of the base line is not limited particularly. The base line may be expressed by a relative coordinate, a polar coordinate, or the like, not just by the absolute coordinate. Also, it may be expressed by a formula. When the base line is expressed by a formula, the base line is expressed by a formula of ax+by +c=0, for example. The base line may be expressed by a bitmap. Note that, while the start point does not coincide with the end point in the base line 21 in FIG. 2, a start point may coincide with an end point.

Next, an operation will be explained.

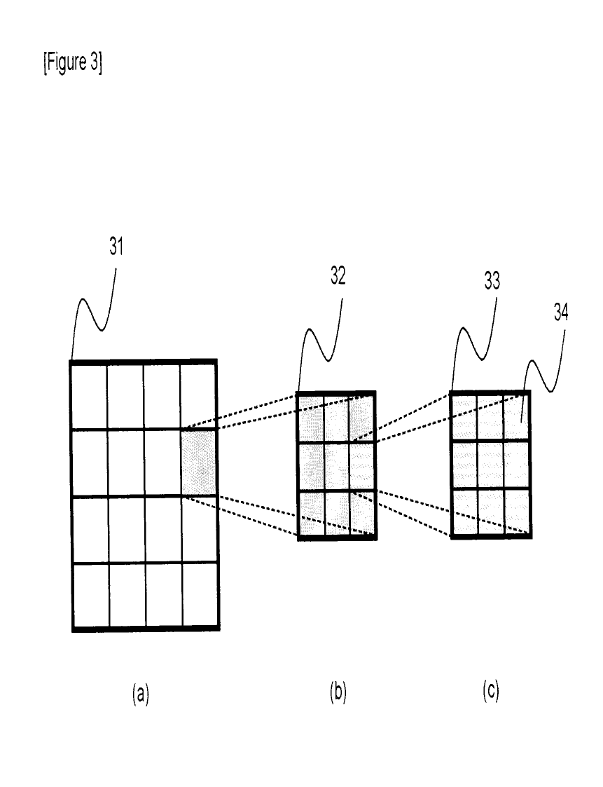

FIG. 3 is a diagram showing division processing in the region division unit 11 according to Embodiment 1. (a) in FIG. 3 shows processing of dividing a large region 31 into 4×4 medium regions in height and width. (b) in FIG. 3 shows processing of dividing a medium region 32 into 3×3 small regions 33 in height and width. (c) in FIG. 3 shows that the small region 33 includes 3×3 elements in height and width. An element 34 is a minimum configuration unit of the large region 31.

The region division unit 11 provides the large region 31 configured with N×M elements on the basis of the image size information of an image rendered by the image-rendering device 10. Note that N may be equal to M. A color value or other data such as a value showing a distance may be set as a pixel in an element of the large region 31.

The region division unit 11 divides the large region 31 into a plurality of medium regions on the basis of the division information, and further divides each medium region into a plurality of small regions. The small region includes a plurality of elements. The division information is information showing the number of division when a large region is divided into medium regions and the number of division when a medium region is divided into small regions.

While the large region 31 is divided into 4×4 medium regions in height and width, the medium region 32 is divided into 3×3 small regions 33 in height and width, and the small region 33 is configured with 3×3 elements in height and width in FIG. 3, the number of division may have another value as long as they are divided into rectangles. Also, the number of division in height may differ from that in width. In addition, the number of division when a large region is divided into medium regions may differ from the number of division when a medium region is divided into small regions. For example, if 5×5 elements are assumed to be included in a small region, processing in a matching unit 103 can be performed at high speed since the total number of small regions is smaller than that when 3×3 elements are included.

The region division unit 11 may change the number of division when a large region is divided into medium regions and the number of division when a medium region is divided into small regions, in accordance with a shape of the base line 21. For example, the number of division may be decreased when the base line 21 is a simple shape not having many corners, and the number of division may be increased when the base line 21 is a complicated shape having many corners. In that case, the base line 21 is inputted to the region division unit 11, and the region division unit 11 outputs the base line 21 to the low resolution data calculation unit 12.

The region division unit 11 outputs the large region 31 divided into medium regions and small regions to the low resolution data calculation unit 12. The low resolution data calculation unit 12 calculates a minimum distance from the base line for each of all small regions included in the large region 31, and sets it to each of the small regions.

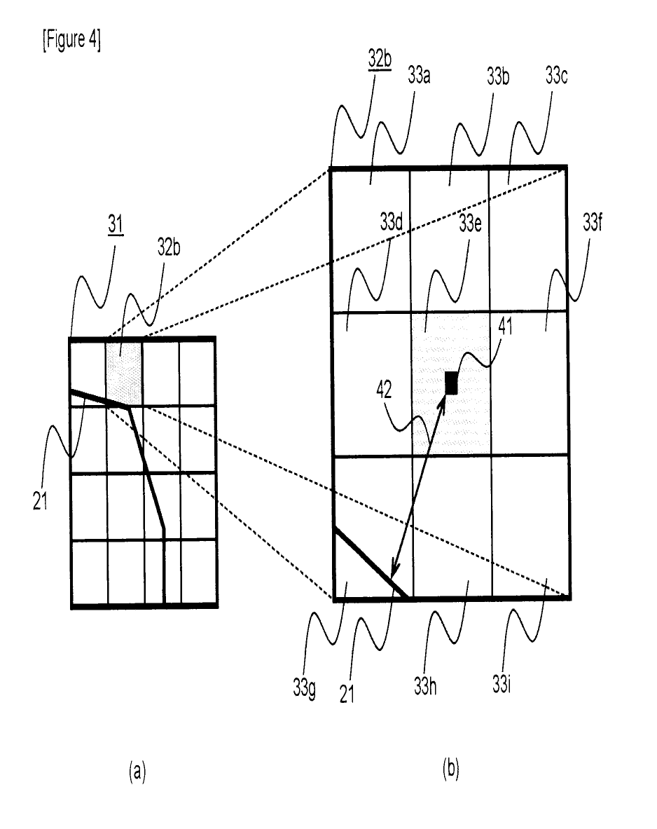

FIG. 4 is a diagram showing a minimum distance between the base line 21 and a small region 33e according to Embodiment 1. (a) in FIG. 4 is a diagram when the base line 21 included in the image 20 is rendered on the large region 31. The large region 31 is divided into 4×4 medium regions in height and width. (b) in FIG. 4 is an enlarged diagram of a medium region 32b. The medium region 32b is divided into 3×3 small regions 33a through 33i in height and width. Part of the base line 21 shown in FIG. 2 passes through the small region 33g. The minimum distance between the base line 21 and the small region 33e is a minimum distance 42 between the base line 21 and a center point 41 of the small region 33e.

The low resolution data calculation unit 12 calculates the minimum distance 42 from the center point 41 of small region 33e to the base line 21. A method for calculating the minimum distance is not particularly limited in the present invention. For example, a formula of a distance between a point and a line may be used to calculate it. When the center point 41 of small region 33e is (x₀, y₀) and the base line 21 is a straight line ax+by +c=0, the minimum distance 42 can be calculated by the formula (1).

$$\begin{matrix}[ Math . 1 ] & \\ D = \frac{\vert a \times {x}_{o} + b \times {y}_{o} + c \vert}{\sqrt{{a}^{2} + {b}^{2}}} & ( 1 )\end{matrix}$$

Note that, while the low resolution data calculation unit 12 calculates a minimum distance from the center point 41 of small region 33e to the base line 21 as the minimum distance between the base line 21 and small region 33e, a distance to the base line 21 from a corner of the small region 33e or from another point in the small region 33e may be calculated as the minimum distance. Also, the low resolution data calculation unit 12 may calculate each minimum distance to the base line 21 from each of four corners configuring the small region 33e, and an average of the minimum distances may be calculated. Here, the low resolution data calculation unit 12 should employ the same calculation method for all small regions. A method shown in PCT/JP2012/000912 may be employed in calculating a minimum distance.

In addition, the low resolution data calculation unit 12 may calculate each minimum distance to the base line 21 from each of four corners configuring the medium region 32b and a minimum distance to the base line 21 from a center point of the medium region 32b, and a minimum distance value to the base line 21 for each of the small regions 33a through 33i may be calculated by using values of the foregoing minimum distances. Note that, not just the four corners configuring the medium region 32b and the center point thereof, the low resolution data calculation unit 12 may calculate a minimum distance value to the base line 21 for each of the small regions 33a through 33i by using values obtained from minimum distances to the base line 21 from other points.

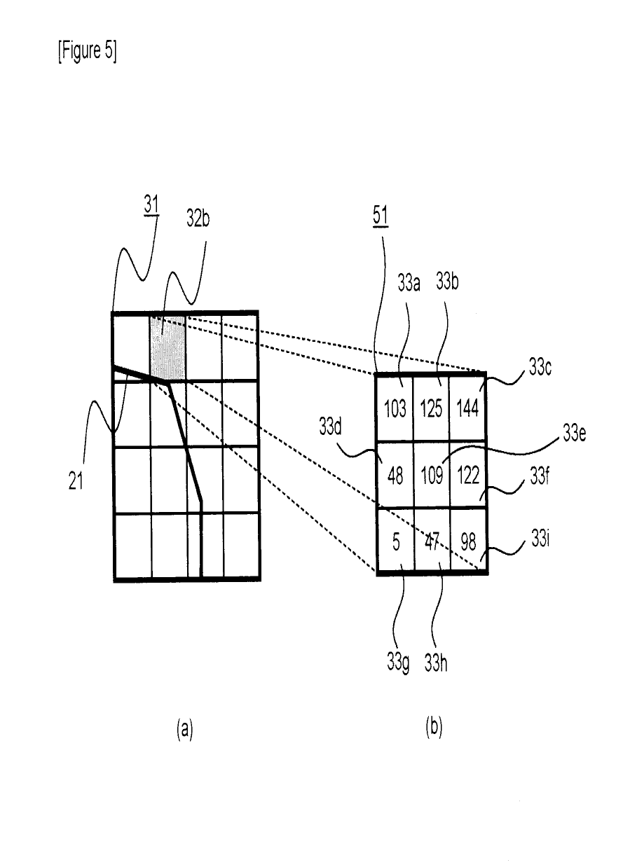

FIG. 5 is a diagram showing a result of calculating a minimum distance from the base line 21 for each of the small regions 33a through 33i included in the medium region 32b according to Embodiment 1. (a) in FIG. 5 is a diagram when the base line 21 included in the image 20 is rendered on the large region 31. The large region 31 is divided into 4×4 medium regions in height and width. (b) in FIG. 5 is an enlarged diagram of the medium region 32b. The medium region 32b is divided into 3×3 small regions 33a through 33i in height and width. A minimum distance from the base line 21 is set for each of the small regions 33a through 33i. A value 103 is set for the small region 33a, 125 for small region 33b, 144 for small region 33c, 48 for small region 33d, 109 for small region 33e, 122 for small region 33f, 5 for small region g, 47 for small region h, and 98 for small region i. A medium region in which each minimum distance from the base line 21 for each of the small regions is set, is to be called as a low resolution distance data 51.

The low resolution data calculation unit 12 calculates a minimum distance from the base line 21 for each of all small regions included in the large region 31, sets each distance to each of the small regions, and outputs them to the matching unit 13.

Data stored in the high resolution data DB 14 will be explained here.

In the image-rendering device 10, the low resolution distance data having various patterns is associated with the high resolution distance data and they are stored in advance in the high resolution data DB 14. The low resolution distance data is data for storing a minimum distance value from the base line for each of small regions. The high resolution distance data is data for storing a minimum distance value from the base line for each of elements.

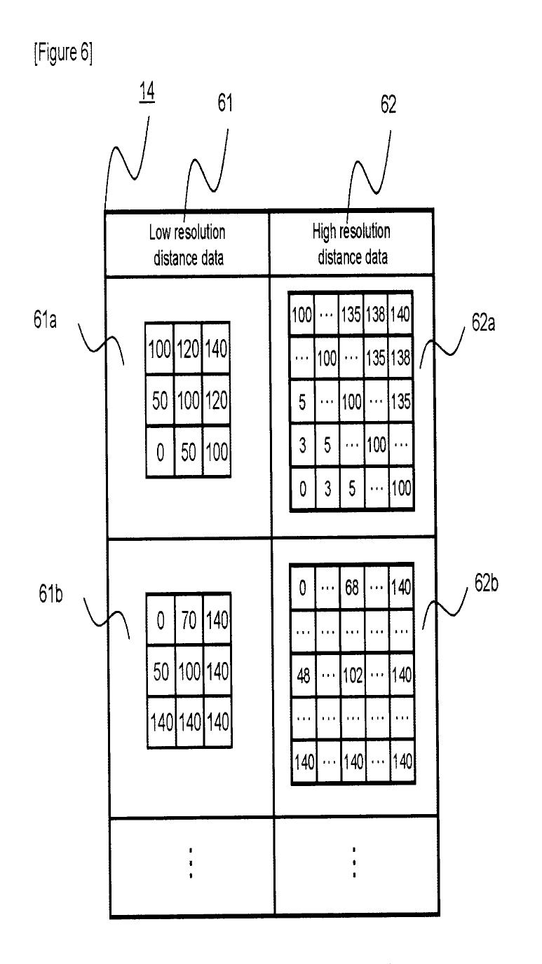

FIG. 6 is a diagram showing data stored in the high resolution data DB 14 according to Embodiment 1. Low resolution distance data 61 and high resolution distance data 62 are stored in the high resolution data DB 14. Minimum distance values are set for a plurality of small regions in the low resolution distance data 61 and minimum distance values are set for a plurality of small elements in the high resolution distance data 62. Low resolution distance data 61a, 61b are specific examples of data stored as the low resolution distance data 61. High resolution distance data 62a, 62b are specific examples of data stored as the high resolution distance data 62.

The high resolution distance data 62a is high resolution distance data associated with the low resolution distance data 61a. In the low resolution distance data 61a, minimum distance values each set for the respective small regions increase from 0 to 140 as moving from the lower left toward the upper right. Also in the high resolution distance data 62a, minimum distance values each set for the respective elements increase from 0 to 140 as moving from the lower left toward the upper right, similar to the low resolution distance data 61a.

The high resolution distance data 62b is high resolution distance data associated with low resolution distance data 61b. In the low resolution distance data 61b, minimum distance values each set for the respective small regions increase from 0 to 140 as moving from the upper left toward the lower right. Also in the high resolution distance data 62b, minimum distance values each set for the respective elements increase from 0 to 140 as moving from the upper left toward the lower right, similar to the low resolution distance data 61b. While two pieces of data are shown as an example here, the low resolution distance data having various patterns is associated with the high resolution distance data and they are stored in the high resolution data DB 14 actually.

The high resolution data DB 14 stores the low resolution distance data 61 and high resolution distance data 62 in a tree structure or a table structure, for example. When values in a piece of low resolution distance data can be obtained by reversing (up/down and/or right/left) or rotating values in another piece of low resolution distance data, only representative piece of data may be associated with high resolution distance data and stored. If processing of reversing or rotating the representative piece of data is performed, desired high resolution data for pieces of data other than the representative piece of data can be restored.

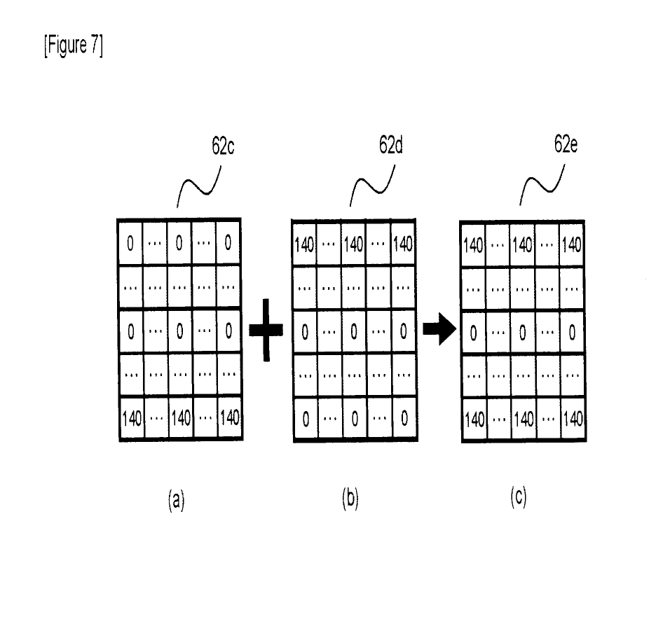

FIG. 7 is a diagram showing data generated by logically summing pieces of high resolution distance data 62 according to Embodiment 1. (a) in FIG. 7 shows high resolution distance data 62c, (b) in FIG. 7 shows high resolution distance data 62d, and (c) in FIG. 7 shows high resolution distance data 62e. In each element of the high resolution distance data 62c through 62e, a value between 0 and 140 is set as a minimum distance value from the base line. Values of elements in the high resolution distance data 62c are all zero at the lines from the uppermost to the center, gradually increase from zero when going down from the center line toward the lowermost line, and are all 140 at the lowermost line.

Values of elements in the high resolution distance data 62d are all 140 at the uppermost line, gradually decrease from 140 when going down from the uppermost line toward the center line, and are all zero at the lines from the center to the lowermost. Values of elements in the high resolution distance data 62e are all 140 at the uppermost line, gradually decrease from 140 to zero when going down from the uppermost line toward the center line, are all zero at the center line, gradually increase from zero when going down from the center line toward the lowermost line, and are all 140 at the lowermost line.

The high resolution distance data 62e is data generated by logically summing the high resolution distance data 62c and the high resolution distance data 62d. When the high resolution distance data 62e is associated with low resolution distance data 61e, the high resolution data DB 14 does not store the high resolution distance data 62e as high resolution distance data associated with the low resolution distance data 61e. The high resolution data DB 14 stores the fact that the high resolution distance data 62e is generated by logically summing the high resolution distance data 62c and the high resolution distance data 62d. Thus, since a piece of high resolution distance data which can be generated by arithmetically operating pieces of high resolution distance data is generated as needed when such a piece of data is necessary, database capacity can be reduced.

The high resolution data DB 14 calculates in advance an evaluation value K and a gravity center G for each piece of low resolution distance data. The evaluation value K is calculated by the formula (2) and formula (3). It is assumed that n small regions are included in the low resolution distance data. It is also assumed that the number of patterns of minimum distance values set for a single small region is the m-th power of two. In the formula (2), dⱼ is a minimum distance value from the base line for the small region concerned. Note that the evaluation value may be calculated by another method as long as a value of uniquely expressing each piece of low resolution distance data can be obtained.

$$\begin{matrix}[ Math . 2 ] & \\ {p}_{j} = [ \frac{{d}_{j}}{{\sum }_{k = 0}^{n - 1} {d}_{k}} \times {2}^{m} + \frac{1}{2} ] & ( 2 ) \\ [ Math . 3 ] & \\ K = {\sum }_{j = 0}^{n - 1} ( {p}_{j} \times {2}^{mj} ) & ( 3 )\end{matrix}$$

The high resolution data DB 14 calculates the gravity center G for each piece of low resolution distance data by using the formula (2) and formula (4). A coordinate value of each small region center is assumed to be (xⱼ, yⱼ). The gravity center may be calculated by another method.

$$\begin{matrix}[ Math . 4 ] & \\ G = ( \frac{1}{n} {\sum }_{j = 0}^{n - 1} {x}_{j} {p}_{j} , \frac{1}{n} {\sum }_{j = 0}^{n - 1} {y}_{j} {p}_{j} ) & ( 4 )\end{matrix}$$

Next, an operation of the matching unit 13 will be explained.

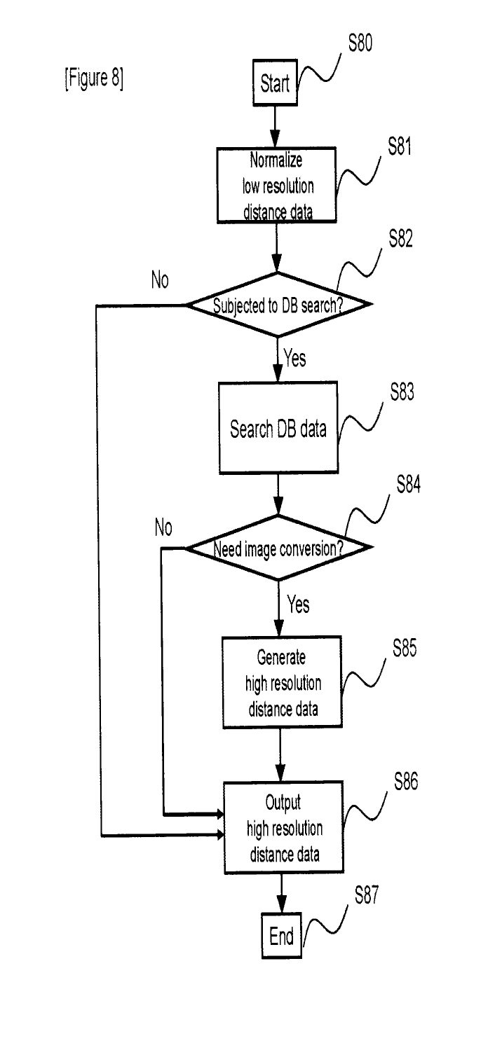

FIG. 8 is a flow chart showing processing of the matching unit 13 according to Embodiment 1. On receiving the low resolution distance data 51 from the low resolution data calculation unit 12, the matching unit 13 starts processing from Step S80 and proceeds to Step S81. In Step S81, the matching unit 13 rounds up or rounds down the minimum distance value set for each small region in the low resolution distance data 51 so as to be normalized, and proceeds to Step S82.

In Step S82, the matching unit 13 accesses the high resolution data DB 14 and determines whether or not search is to be conducted. If all values of the small regions in normalized low resolution distance data 51 are no less than a first threshold value or no more than a second threshold value, the unit determines that the data is not subjected to DB search and proceeds to Step S86. Otherwise, proceeds to Step S83. The matching unit 103 sets values in advance in the first threshold value and second threshold value.

When a minimum distance value set in a small region is the first threshold value or more, the small region has a long distance from the base line. For example, when the minimum distance values, from the base line, each set for the respective small regions has a range between zero and 140, a value of 140 is set for all elements in the small region concerned. On the other hand, when a minimum distance value set in a small region is the second threshold value or less, the small region has a short distance from the base line. In that case, a value of zero is set for all elements in the small region concerned. Thus, when the low resolution distance data 51 is not subjected to the DB search, the matching unit 13 can set a value to each element without accessing the high resolution data DB 14.

In Step S83, the matching unit 13 calculates the evaluation value K and gravity center G for the low resolution distance data 51. The matching unit 13 searches the high resolution data DB 14 by employing the evaluation value K of low resolution distance data 51 as a key. If the matching unit 13 finds low resolution distance data 61a whose evaluation value K coincides with that of the low resolution distance data 51, it proceeds to Step S84. Note that the search may be conducted by using a template matching method. The template matching method is a method of performing comparison on a pixel by pixel basis.

In Step S84, the matching unit 13 determines whether or not high resolution distance data 62a is directly associated with the low resolution distance data 61a. When the high resolution distance data 62a is not directly associated with the low resolution distance data 61a, it is necessary for the matching unit 13 to obtain high resolution data by performing image conversion of other high resolution distance data. When the high resolution distance data 62a is directly associated with the low resolution distance data 61a, the matching unit 13 compares a gravity center value of the low resolution distance data 51 with a gravity center value of the low resolution distance data 61a. If the gravity center values are the same, no image conversion is needed. If the gravity center values differ, image conversion is needed. When the image conversion is needed, the process proceeds to Step S85. When the image conversion is not needed, it proceeds to Step S86.

In Step S85, when the high resolution distance data 62a is not directly associated with the low resolution distance data 61a, the matching unit 13 performs image conversion such as logical summing by referring to other high resolution distance data, and generates high resolution distance data associated with the low resolution distance data 61a. When the high resolution distance data 62a is directly associated with the low resolution distance data 61a, the matching unit 13 calculates the difference between the gravity center of low resolution distance data 51 and the gravity center of low resolution distance data 61a. The matching unit 13 calculates desired high resolution distance data by reversing or rotating the high resolution distance data 62a, and proceeds to Step S86. In Step S86, the matching unit 13 outputs the obtained high resolution distance data 62a to the high resolution data setting unit 15, proceeds to Step S87, and terminates the processing.

The high resolution data setting unit 15 sets high resolution distance data to all medium regions included in the large region 31, and outputs it to the high resolution color value conversion unit 16. The high resolution color value conversion unit 16 converts a minimum distance value set for each element into a color value by referring to the color value conversion table 17.

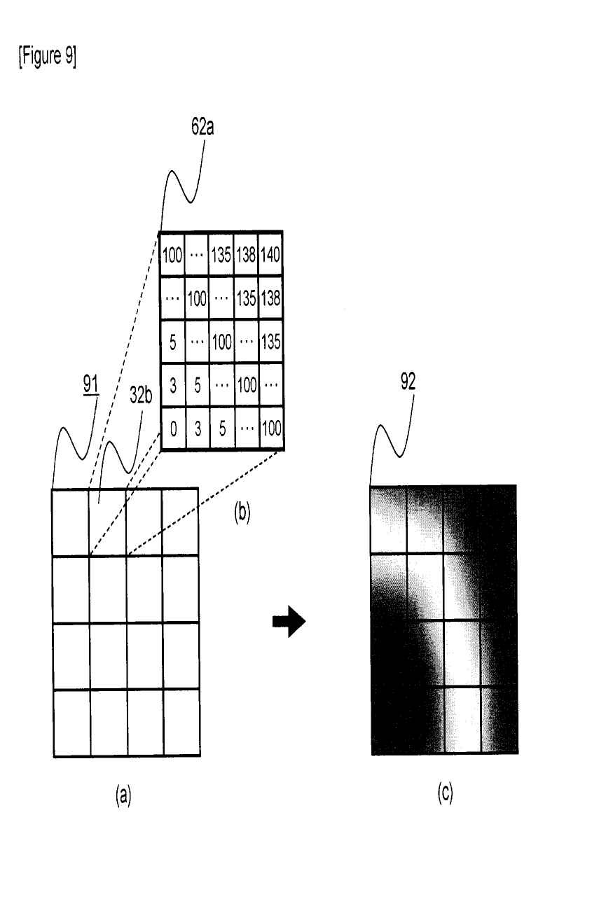

FIG. 9 is a diagram showing conversion from high resolution distance data into high resolution color value data according to Embodiment 1. (a) in FIG. 9 is a large region 91 in which high resolution distance data is set for each medium region. (b) in FIG. 9 is an enlarged diagram of the medium region 32b and is a diagram showing high resolution distance data 62a set in the medium region 32b. (c) in FIG. 9 is a large region 92 obtained by converting high resolution distance data set in each medium region into high resolution color value data. If high resolution distance data set in each medium region of the large region 91 is converted into high resolution color value data, the large region 92 can be obtained.

A table for converting minimum distance values Di into color values Ci is stored in the color value conversion table 17 in advance. The color value Ci is a value represented by RGB, for example. In the color value conversion table 17, the minimum distance value Di may be associated with the color value Ci on a one-on-one basis, or the minimum distance values between Dj and Dk may be associated with the color value Ci. Note that the high resolution color value conversion unit 16 may convert the minimum distance value Di into the color value Ci by using a calculation formula, without using the color value conversion table 17.

By converting a minimum distance value of each element into a color value, the high resolution color value conversion unit 16 obtains the large region 92 in which a color value is set for each element, from the large region 91 in which a minimum distance value is set for each element. The high resolution color value conversion unit 16 outputs the large region 92 to the rendering unit 18. The large region 92 is a gradation image. The rendering unit 18 renders gradation and outputs it.

In the present embodiment, a large region whose minimum configuration unit is an element is divided into small regions each configured with the elements; low resolution distance data showing a minimum distance from a base line serving as a reference for color change in gradation is calculated for each of the small regions; low resolution distance data for storing each minimum distance from the base line for each of the small regions is associated with high resolution distance data for storing each minimum distance from the base line for each of the elements and they are stored in the high resolution data DB 14; high resolution distance data associated with low resolution distance data, from among the low resolution distance data stored in the high resolution data DB 14, which coincides with the calculated low resolution distance data is obtained from the high resolution data DB 14; the obtained high resolution distance data is converted into high resolution color value data for storing a color value for each of the elements; and gradation is rendered on the basis of the converted high resolution color value data. Therefore, since it is not necessary to calculate the minimum distance from the base line for all pixels, the number of times for calculating the minimum distance can be reduced.

Thus, gradation can be rendered at higher speed than before. Also, since accessing the high resolution data DB 14 is not necessary when minimum distances set in all small regions included in low resolution distance data are no less than the first threshold value or no more than the second threshold value, gradation can be rendered even faster.

### Embodiment 2

While a minimum distance from a base line is set in each small region as low resolution data in Embodiment 1 above, an embodiment in which a color value is set in each small region will be shown in the present embodiment.

Note that, since the region division unit 11, low resolution data calculation unit 12, and rendering unit 18 in Embodiment 2 are the same with those in Embodiment 1, their description will be omitted.

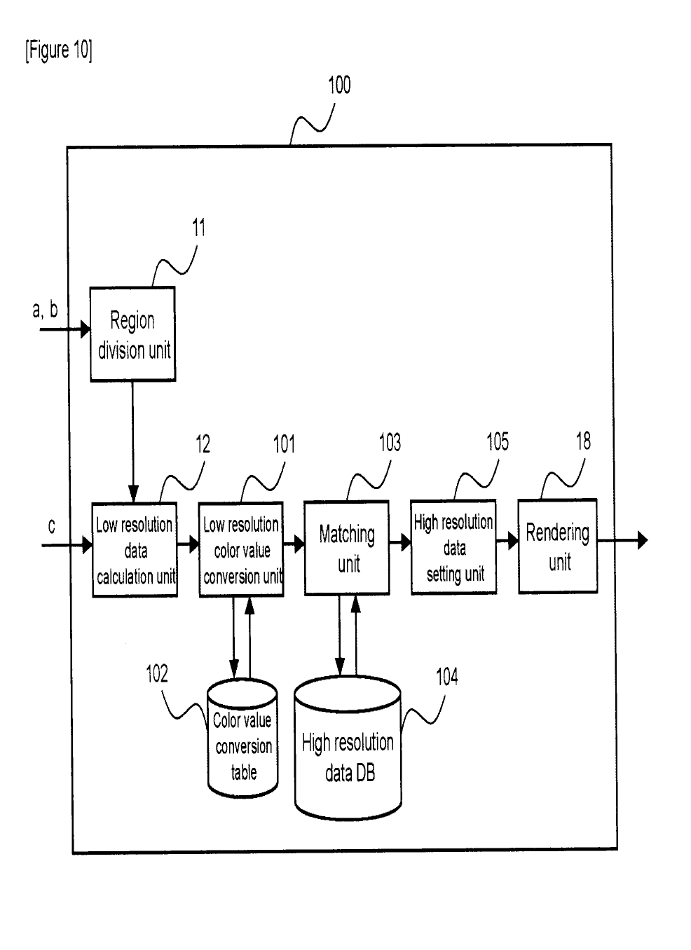

FIG. 10 is a block diagram showing a configuration of an image-rendering device 100 according to Embodiment 2.

Low resolution distance data is inputted to a low resolution color value conversion unit 101 from the low resolution data calculation unit 12. By referring to a color value conversion table 102, the low resolution color value conversion unit 101 converts the low resolution distance data into low resolution color value data, and outputs it to the matching unit 103. The low resolution color value data is data in which a color value corresponding to a minimum distance from the base line is set for each small region 33.

The low resolution color value data is associated with high resolution color value data and they are stored in advance in a high resolution data DB 104 serving as a high resolution data store unit. The high resolution color value data is data in which a minimum distance from the base line is set for each element. The matching unit 103 accesses the high resolution data DB 104, conducts search by employing the low resolution color value data inputted from the low resolution color value conversion unit 101 as a key, obtains the high resolution color value data, and outputs it to a high resolution data setting unit 105. The high resolution data setting unit 105 sets the high resolution color value data for each medium region, and outputs it to the rendering unit 18. The rendering unit 18 renders a gradation image and outputs it.

Next, an operation will be explained.

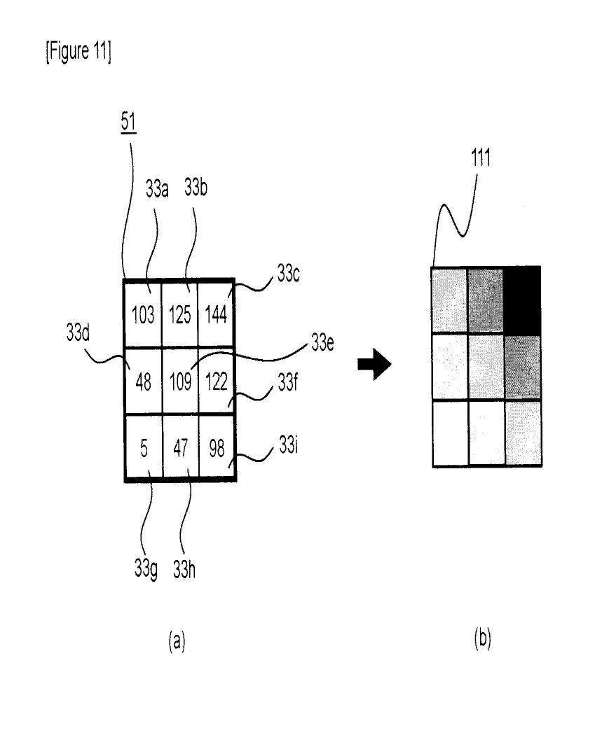

FIG. 11 is a diagram showing conversion from the low resolution distance data 51 into low resolution color value data 111 according to Embodiment 2. (a) in FIG. 11 is the low resolution distance data 51. Minimum distance values set in the small regions 33a through 33i in low resolution distance data 51 increase as moving from the lower left toward the upper right. The low resolution distance data 51 is configured with the 3×3 small regions 33a through 33i in height and width, and a minimum distance from the base line 21 is set for each of the small regions. A value 103 is set for the small region 33a, 125 for small region 33b, 144 for small region 33c, 48 for small region 33d, 109 for small region 33e, 122 for small region 33f, 5 for small region g, 47 for small region h, and 98 for small region i.

(b) in FIG. 11 is the low resolution color value data 111 converted from the low resolution distance data 51. The minimum distance values set in the small regions 33a through 33i are converted into color values, and the color values are set in the low resolution color value data 111 so as to change from white to black as moving from the lower left toward the upper right.

By referring to the color value conversion table 102, the low resolution color value conversion unit 101 converts the minimum distance value from the base line set for each small region in the low resolution distance data 51 into the color value, and thus obtains the low resolution color value data 111. A table for converting minimum distance values Di (i=1˜N) into color values Ci (i=1˜N) is stored in the color value conversion table 102 in advance.

In the color value conversion table 102, similar to the color value conversion table 17 in Embodiment 1, the minimum distance value Di may be associated with the color value Ci on a one-on-one basis, or the minimum distance values between Dj and. Dk may be associated with the color value Ci. Note that the low resolution color value conversion unit 101 may convert the minimum distance value Di into the color value Ci by using a calculation formula, without using the color value conversion table 102. The low resolution color value conversion unit 101 outputs the obtained low resolution color value data 111 to the matching unit 103.

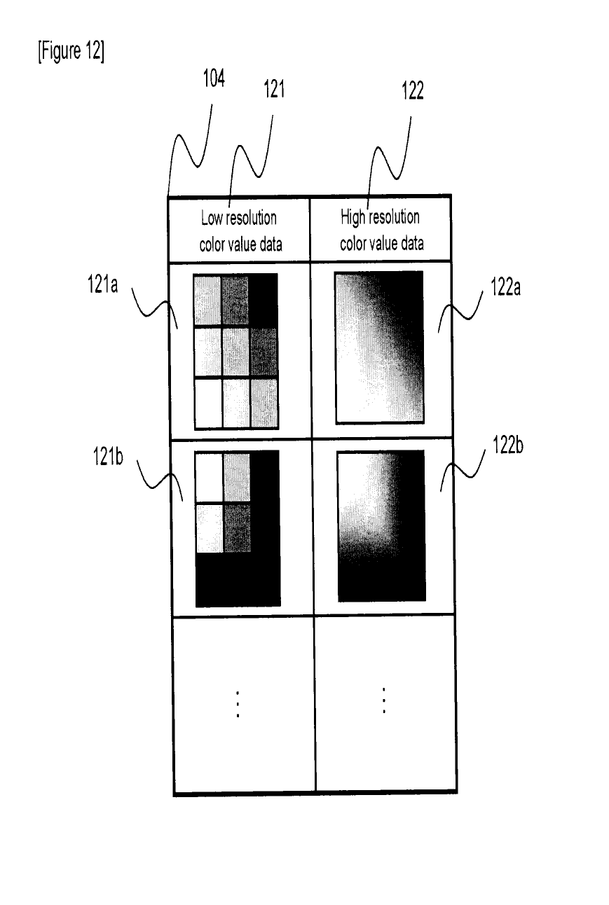

FIG. 12 is a diagram showing data stored in the high resolution data DB 104 according to Embodiment 2. Low resolution color value data 121 is associated with high resolution color value data 122 and they are stored in the high resolution data DB 104. The low resolution color value data 121 is data for storing color values in a plurality of small regions. The high resolution color value data 122 is data for storing color values in a plurality of small elements. Low resolution color value data 121a, 121b are specific examples of data stored as the low resolution color value data 121. High resolution color value data 122a, 122b are specific examples of data stored as the high resolution color value data 122.

The high resolution color value data 122a is high resolution color value data associated with the low resolution color value data 121a. In the low resolution distance data 121a, color values each set for the respective small regions change from white to black as moving from the lower left toward the upper right. Also in the high resolution color value data 122a, color values each set for the respective elements change from white to black as moving from the lower left toward the upper right, similar to the low resolution color value data 121a.

The high resolution color value data 122b is high resolution color value data associated with low resolution color value data 121b. In the low resolution color value data 121b, color values each set for the respective small regions change from white to black as moving from the upper left toward the lower right. Also in the high resolution color value data 122b, color values each set for the respective elements change from white to black as moving from the upper left toward the lower right, similar to the low resolution color value data 121b. While two pieces of data are shown as an example here, the low resolution color value data having various patterns is associated with the high resolution color value data and they are stored in the high resolution data DB 104 actually.

The high resolution data DB 104 calculates in advance an evaluation value K and a gravity center G for the low resolution color value data 121. While a method for calculating the evaluation value K and gravity center G is not limited, they may be calculated by the formula (3) and formula (4), for example, similar to Embodiment 1. In the present embodiment, pⱼ in the formula (3) and formula (4) is calculated by the formula (5). In the formula (5), cⱼ is assumed to be a color value of the small region concerned. The number of small regions included in the low resolution distance data is assumed to be n. The number of patterns of color values set for a single small region is assumed to be the m-th power of two.

$$\begin{matrix}[ Math . 5 ] & \\ {p}_{j} = [ \frac{{c}_{j}}{{\sum }_{k = 0}^{n - 1} {c}_{k}} \times {2}^{m} + \frac{1}{2} ] & ( 5 )\end{matrix}$$

The matching unit 103 calculates the evaluation value K and gravity center G for the low resolution color value data 111 inputted from the low resolution color value conversion unit 101. The matching unit 103 searches the high resolution data DB 104 by employing the evaluation value of low resolution color value data 111 as a key, and obtains the associated high resolution color value data 122a.

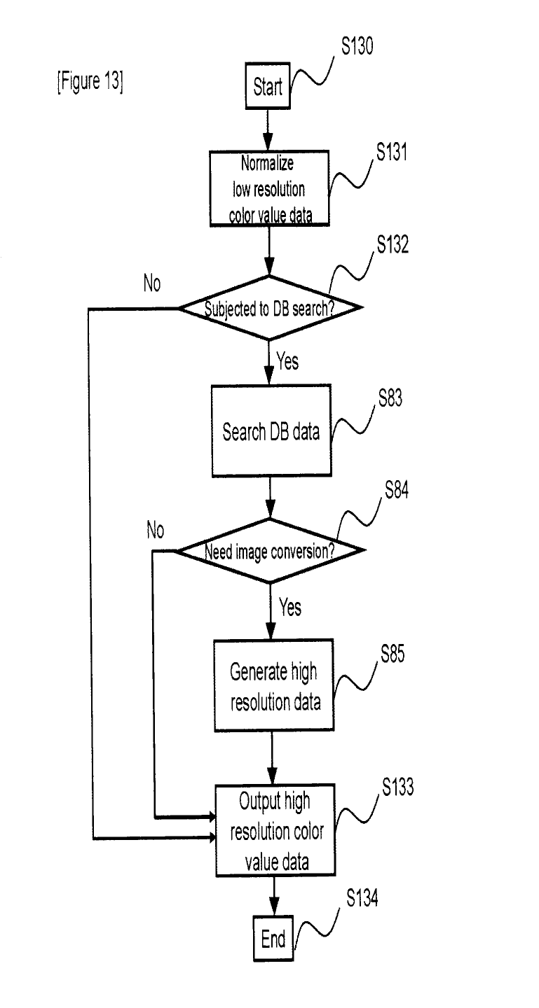

FIG. 13 is a flow chart showing processing of the matching unit 103 according to Embodiment 2. Steps S83 through S85 in the flow chart are the same with those in FIG. 8 in Embodiment 1. While high resolution distance data associated with low resolution distance data is obtained in Embodiment 1, high resolution color value data associated with low resolution color value data is obtained by the matching unit 103 in Embodiment 2.

On receiving, from the low resolution data calculation unit 12, the low resolution data 111 in which a color value is set for each small region in accordance with a minimum distance from the base line 21, the matching unit 103 starts processing from Step S130 and proceeds to Step S131. In Step S131, the matching unit 103 rounds up or rounds down the color value set for each small region in the low resolution data 111 so as to be normalized, and proceeds to Step S132.

In Step S132, the matching unit 103 accesses the high resolution data DB 104 and determines whether or not search is to be conducted. If all color values of the small regions in normalized low resolution data 111 are no less than a third threshold value or no more than a fourth threshold value, the unit determines that the data is not subjected to DB search and proceeds to Step S133. Otherwise, proceeds to Step S83. The matching unit 103 sets values in advance in the third threshold value and fourth threshold value.

A color change set in a small region is assumed to be from color A to color B, for example. When a color value set in a small region is the third threshold value or more, the small region has a long distance from the base line. In that case, color B is set for the small region concerned. On the other hand, when a color value set in a small region is the fourth threshold value or less, the small region has a short distance from the base line. In that case, color A is set for the small region concerned. Thus, when the low resolution color value data 111 is not subjected to the DB search, the matching unit 103 can set a color value without accessing the high resolution data DB 104.

In Step S83, the matching unit 13 calculates the evaluation value of low resolution color value data 111 by the formula (3) and formula (5), and the gravity center thereof by the formula (4) and formula (5). Other processing in Steps S83 through S85 is similar to that in Embodiment 1. In Step S133, the matching unit 13 outputs the obtained high resolution color value data 122a to the high resolution data setting unit 105, proceeds to Step S134, and terminates the processing.

The high resolution data setting unit 105 sets high resolution color value data for all medium regions included in the large region 31, and outputs it to the rendering unit 18. The rendering unit 18 renders gradation based on the high resolution color value data, and outputs it.

In the present embodiment, a large region whose minimum configuration unit is an element is divided into small regions each configured with the elements; low resolution distance data showing a minimum distance from a base line serving as a reference for color change in gradation is calculated for each of the small regions; the low resolution distance data is converted into low resolution color value data showing a color value for each of the small regions; low resolution color value data for storing each color value for each of the small regions is associated with high resolution color value data for storing each color value for each of the elements and they are stored in the high resolution data DB 104; high resolution color value data associated with low resolution color value data, from among the low resolution color value data stored in the high resolution data DB 104, which coincides with the converted low resolution color value data is obtained from the high resolution data DB 104; and gradation is rendered on the basis of the obtained high resolution color value data. Therefore, since it is not necessary to calculate the minimum distance from the base line for all pixels, the number of times for calculating the minimum distance can be reduced.

Thus, gradation can be rendered at higher speed than before. Also, since accessing the high resolution data DB 104 is not necessary when color values set in all small regions included in low resolution color value data are no more than the third threshold value or no less than the fourth threshold value, gradation can be rendered even faster.

### Embodiment 3

While a color value in accordance with a minimum distance from a base line is set in each small region as low resolution data in Embodiment 2 above, an embodiment in which a minimum distance value is set as low resolution data, the distance value is converted into a blend ratio, and the blend ration is converted into a color value, will be shown in the present embodiment. A blend ratio is a value showing a ratio when two colors are mixed. The blend ratio only shows a ratio and is a value independent of a color value.

Note that, since the region division unit 11, low resolution data calculation unit 12, matching unit 13, high resolution data DB 14, high resolution data setting unit 15, and rendering unit 18 in Embodiment 3 are the same with those in Embodiment 1, their description will be omitted.

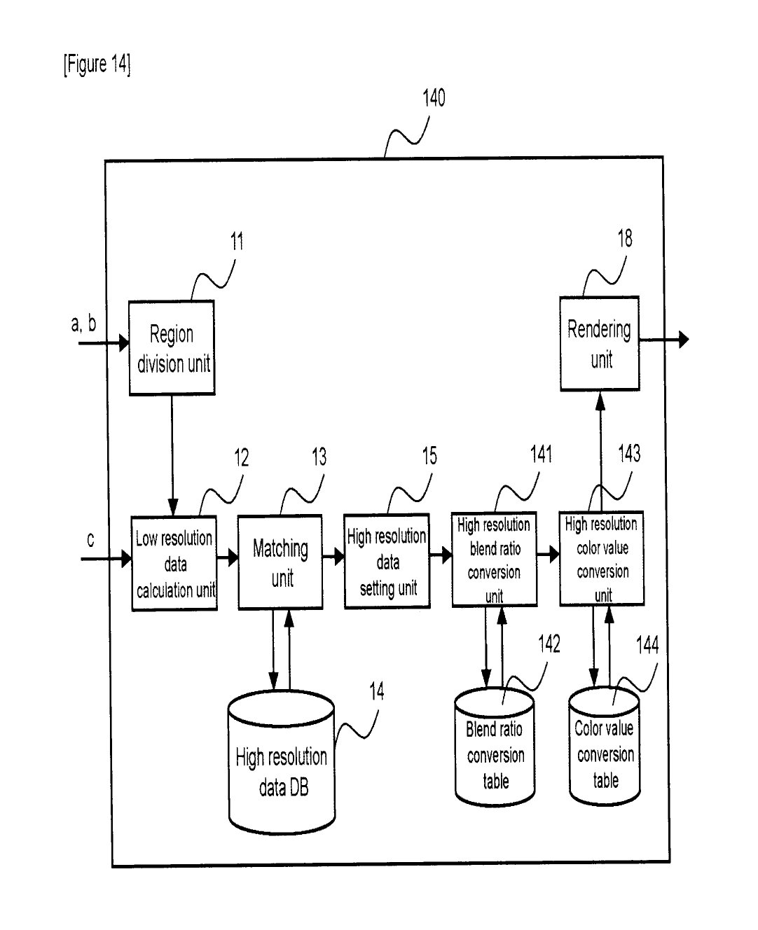

FIG. 14 is a block diagram showing a configuration of an image-rendering device 140 according to Embodiment 3.

Data in which high resolution distance data is set for all medium regions included in the large region 31 is inputted to a high resolution blend ratio conversion unit 141. The high resolution blend ratio conversion unit 141 converts the high resolution distance data into high resolution blend ratio data by converting a minimum distance from the base line for each element into a blend ratio with reference to a blend ratio conversion table 142, and outputs it to a high resolution color value conversion unit 143. The high resolution color value conversion unit 143 converts the high resolution blend ratio data into high resolution color value data by converting a blend ratio for each element into a color value with reference to a color value conversion table 144, and outputs it to the rendering unit 18.

A blend ratio of Si:Ti shows that color A and color B are mixed at a ratio of Si:Ti. In the blend ratio conversion table 142, a table for converting a minimum distance value Di into a blend ratio of Si:Ti is stored in advance. In the blend ratio conversion table 142, the minimum distance value Di may be associated with the blend ratio of Si:Ti on a one-on-one basis, or the minimum distance values between Dj and Dk may be associated with the blend ratio of Si:Ti. Note that the high resolution blend ratio conversion unit 141 may convert the minimum distance value Di into the blend ratio of Si:Ti by using a calculation formula, without using the blend ratio conversion table 142.

In the color value conversion table 144, a table for converting a blend ratio of Si:Ti into a color value Ci is stored in advance. In the color value conversion table 17, the blend ratio of Si:Ti may be associated with the color value Ci on a one-on-one basis, or the blend ratios having some range may be associated with the color value Ci. Note that the high resolution color value conversion unit 143 may convert the blend ratio of Si:Ti into the color value Ci by using a calculation formula, without using the blend ratio conversion table 144.

In the present embodiment, high resolution distance data obtained from the matching unit 13 is converted into high resolution blend ratio data for storing a blend ratio which shows a color value mix ratio for each of the elements; the high resolution blend ratio data is converted into high resolution color value data for storing a color value for each of the elements; and gradation is rendered on the basis of the converted high resolution color value data. Therefore, gradation can be easily rendered even if color values to be used in the gradation are changed.

### Embodiment 4

While a value for each element is converted from a distance into a blend ratio and then converted from the blend ratio into a color value in Embodiment 3 above, an embodiment in which high resolution data is obtained without using a high resolution data DB will be shown in the present embodiment.

Note that, since all components other than a high resolution data conversion unit 151 in Embodiment 4 are the same with those in Embodiment 1, their description will be omitted.

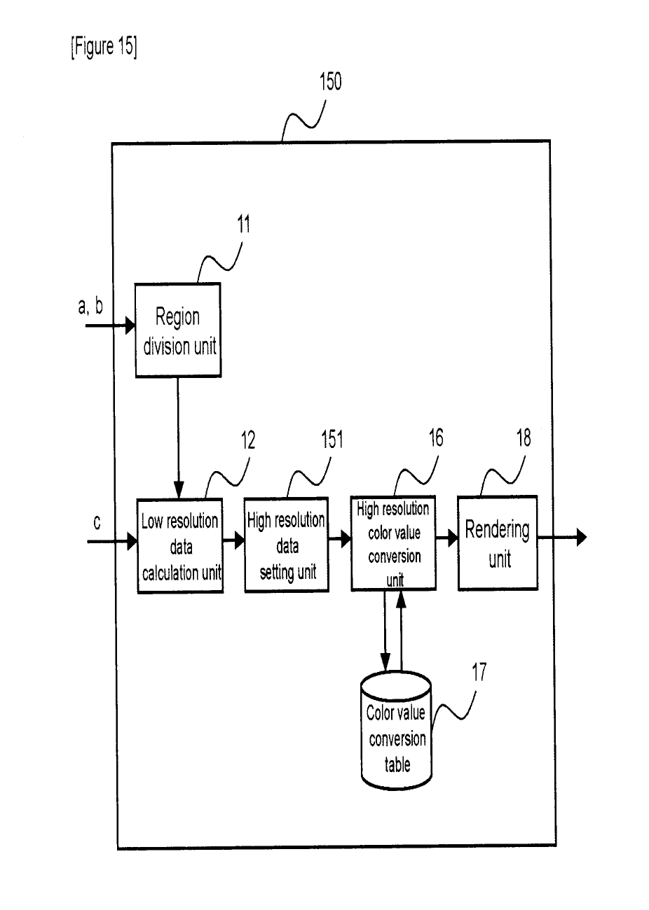

FIG. 15 is a block diagram showing a configuration of an image-rendering device 150 according to Embodiment 4.

The low resolution distance data 51 is inputted to the high resolution data conversion unit 151 from the low resolution data calculation unit 12. A minimum distance from the base line 21 is set for each small region 33 in the low resolution distance data 51. The high resolution data conversion unit 151 expands the low resolution data 51 into high resolution distance data by employing algorithm such as a Bilinear method, a Bicubic method, or an area averaging method (average pixel method), and outputs it to the high resolution color value conversion unit 16.

Note that the image-rendering device 150 does not calculate the low resolution distance data 51 in the region division unit 11 and low resolution data calculation unit 12, but; may calculate by other methods. For example, a method shown in PCT/JP2010/001048 may be employed to calculate the low resolution distance data 51. While each element value is calculated in PCT/JP2010/001048, a value of each small region can be calculated similarly.

In the present embodiment, a large region whose minimum configuration unit is an element is divided into small regions each configured with the elements; low resolution distance data showing a minimum distance from a base line serving as a reference for color change in gradation is calculated for each of the small regions; high resolution distance data showing a minimum distance from the base line is calculated, from the calculated low resolution distance data, for each of the elements by employing algorithm; the calculated high resolution distance data is converted into high resolution color value data for storing a color value of each of the elements; and gradation is rendered on the basis of the high resolution color value data. Therefore, since it is not; necessary to keep a high resolution data DB, memory utilization can be reduced.

### Embodiment 5

While low resolution distance data is expanded to high resolution distance data by employing algorithm in Embodiment 4 above, an embodiment in which a gradation effect is applied to an image by using an alpha channel will be shown in the present embodiment.

Note that, since all components other than a rendering unit 161 in Embodiment 5 are the same with those in Embodiment 1, their description will be omitted.

An alpha channel is a value for showing opacity of each element. When a definition range of alpha channel a is between zero and 255, a value of a pixel in which a foreground and a background are alpha-blended can be calculated by the formula (6).

[Math. 6]

(Pixel)=(Foreground color)×(α/255)+(Background color)×((255−α)/255) (6)

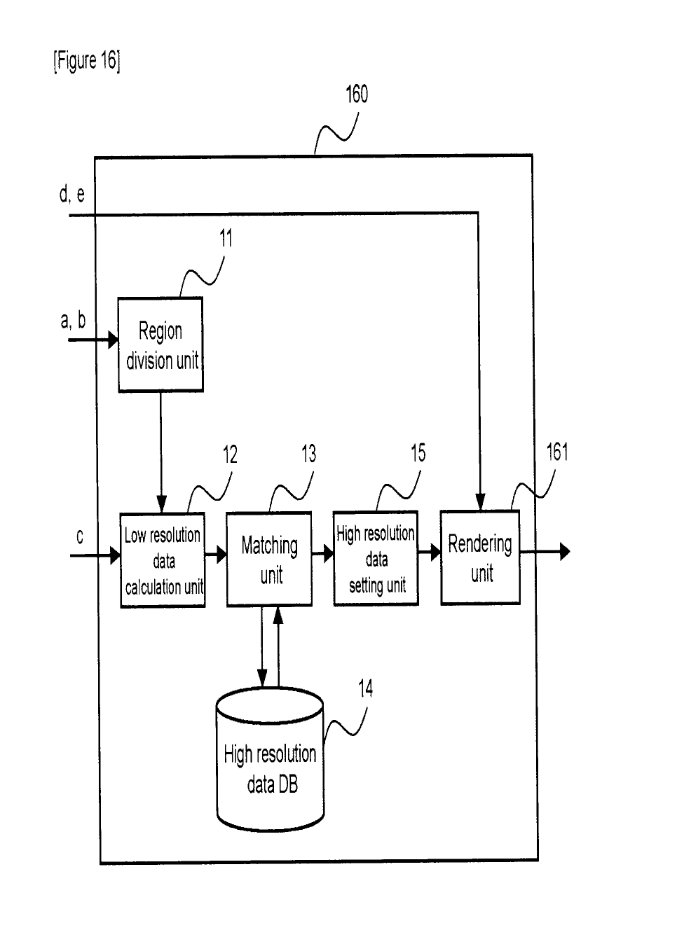

FIG. 16 is a block diagram showing a configuration of an image-rendering device 160 according to Embodiment 5. The high resolution data setting unit 15 sets high resolution distance data in all medium regions included in the large region, and outputs it to the rendering unit 161. In addition, a foreground image d and a background image e are inputted to the rendering unit 161. The rendering unit 161 calculates an alpha channel value for each pixel on the basis of the high resolution distance data, renders an image in which the foreground image and the background image are alpha-blended, and outputs it.

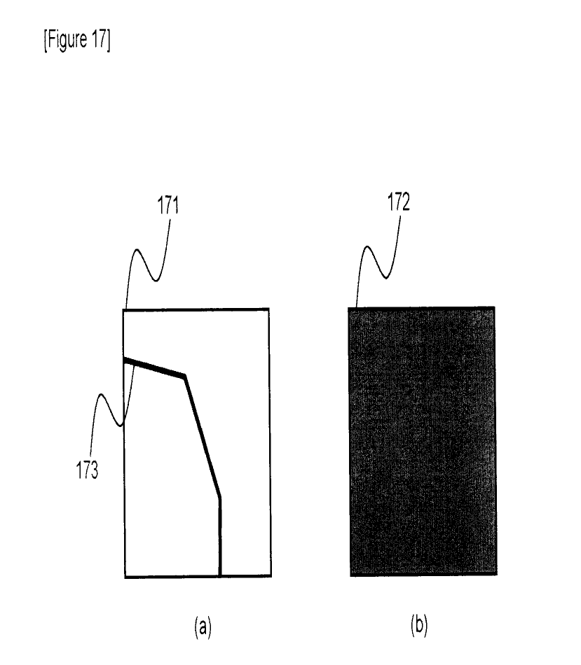

FIG. 17 is a diagram showing a foreground image 171 and a background image 172 according to Embodiment 5. (a) in FIG. 17 is the foreground image 171. The foreground image 171 includes a base line 173. (b) in FIG. 17 is the background image 172.

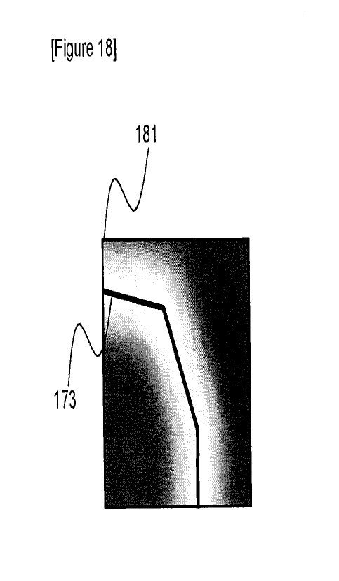

FIG. 18 is a diagram showing an image 181 according to Embodiment 5. The image 181 is an image in which the foreground image 171 including the base line 173 and the background image 172 are alpha-blended.

Next, an operation will be explained.

The foreground image 171 and background image 172 are inputted to the rendering unit. The foreground image 171 and background image 172 may be image data having a raster form, or may be image data having a vector form. When the base line 173 is included in the foreground image 171, the base line 173 extracted from the foreground image 171 is inputted to the low resolution data calculation unit 12. When no base line is included in the foreground image, the base line is inputted to the low resolution data calculation unit 12 as data being separated from the foreground image.

Data in which high resolution distance data is set for all medium regions included in the large region 31 is inputted to the rendering unit 161. The rendering unit 161 calculates an alpha channel value on the basis of each element value in the large region. For example, when minimum distance values are between zero and 140, alpha channel values are set so that a minimum value zero means transparent and a maximum value 140 means opaque. The rendering unit 161 renders the image 181 by alpha-blending the foreground image 171 and background image 172 in accordance with the formula (6), and outputs it.

As to the foreground image 171 and background image 172, not just image data, but RGB color values or blend ratios may be employed. Also, the foreground image 171 may include no images other than the base line 173.

Note that the image-rendering device 160 may obtain high resolution distance data without using the high resolution data DB 14, similar to Embodiment 4. In that case, the image-rendering device 160 does not include the matching unit 13 and high resolution data DB 14, and the high resolution data setting unit 15 performs, subsequent to the low resolution data calculation unit 12, processing similar to that by the high resolution data setting unit 151.

In the present embodiment, a large region whose minimum configuration unit is an element is divided into small regions each configured with the elements; low resolution distance data showing a minimum distance from a base line serving as a reference for color change in gradation is calculated for each of the small regions; the low resolution distance data for storing each minimum distance from the base line for each of the small regions is associated with high resolution distance data for storing each minimum distance from the base line for each of the elements and they are stored in the high resolution data DB 14; high resolution distance data that is associated with low resolution distance data, from among the low resolution distance data stored in the high resolution data DB 14, which coincides with the calculated low resolution distance data is obtained from the high resolution data DB 14; an alpha channel value is calculated on the basis of the obtained high resolution distance data; and an image in which a foreground image and a background image are alpha-blended is rendered. Thus, since it is not necessary to calculate the minimum distance from the base line for all pixels, the number of times for calculating the minimum distance can be reduced. Therefore, an image to which a gradation effect is applied can be rendered at higher speed than before.

### Embodiment 6

While an alpha channel value is calculated on the basis of high resolution distance data and a foreground image and a background image are alpha-blended in Embodiment 5 above, an embodiment in which a gradation effect is applied to a route guide display screen of a car navigation device will be shown in the present embodiment.

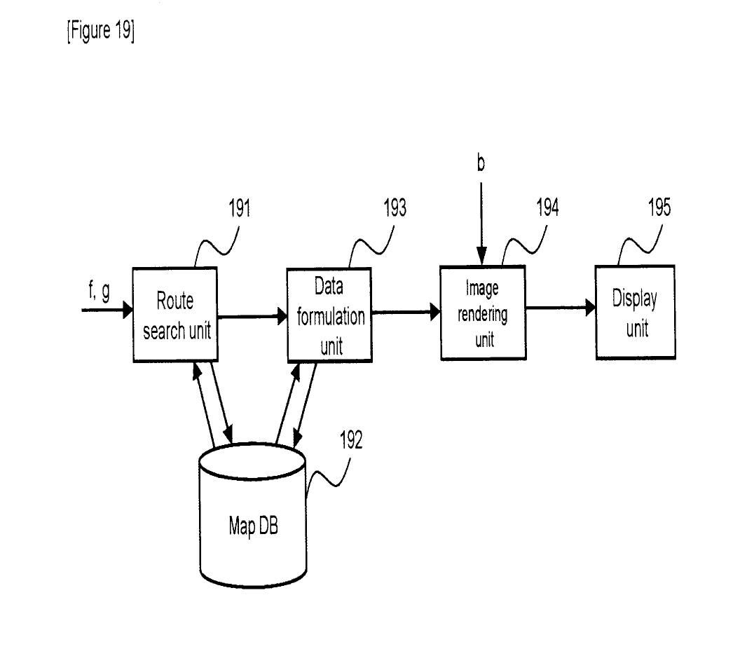

FIG. 19 is a block diagram showing a configuration of a principal part of a car navigation device according to Embodiment 6. On receiving a current vehicle position f and a destination g, a route search unit 191 searches a route from the current position to the destination by referring to a map DB 192. The route search unit 191 inputs the route as a base line to a data formulation unit 193. The data formulation unit 193 generates a map image including the route by referring to the map DB 192, and inputs the image including the base line to an image rendering unit 194. The image rendering unit 194 renders an output image by alpha-blending a map image and a car navigation background image, and outputs it to a display unit 195. The display unit 195 displays the output image on a screen.

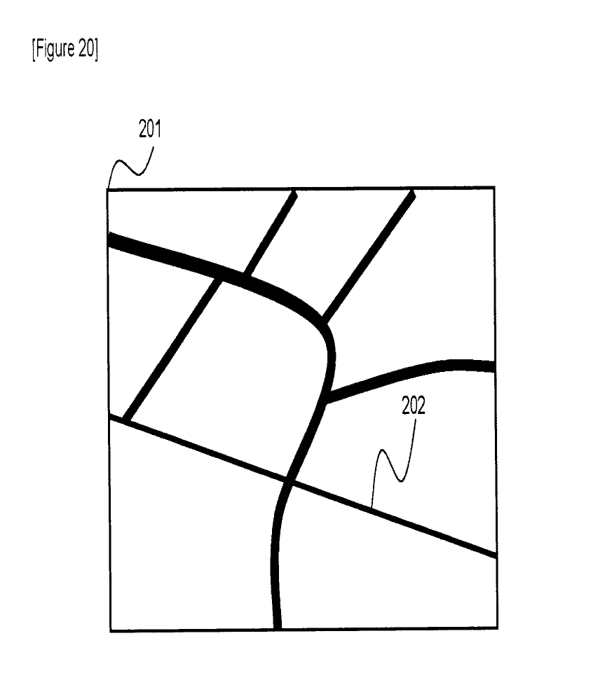

FIG. 20 is a diagram showing a map image 201 according to Embodiment 6. Black lines show roads 202.

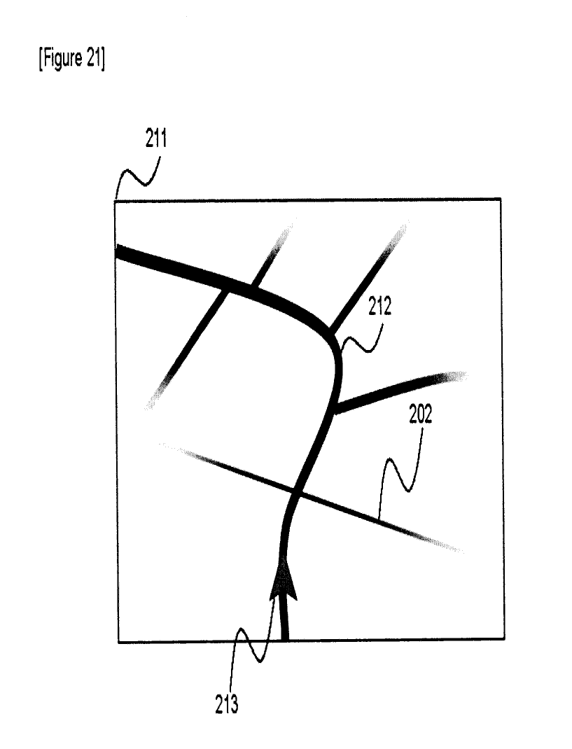

FIG. 21 is a diagram showing an output image 211 displayed on a car navigation screen according to Embodiment 6. A route 212 is a route searched by the route search unit 191. While a route is displayed by a color different from that of other roads in a general car navigation device, the route 212 is shown by black which is the same color with other roads since the image is monochrome. An arrow 213 shows a current vehicle position. A background image is white. The route 212 and roads adjacent to the route 212 are displayed in black, and the color of road 202 changes from black to white being a background color as moving away from the route 212.

On receiving the current vehicle position f and destination g, the route search unit 191 searches the route 212 from the current position to the destination by referring to the map DB 192. The map DB is data in which map data such as roads, signals, and facilities is expressed by coordinates, links, nodes, and the like. The route search unit 191 inputs the route 212 as a base line to the data formulation unit 193. If the route 212 cannot be displayed within a single screen, part of the route 212 to be displayed on the screen is inputted to the data formulation unit 193 as the base line.

On receiving the route 212 from the route search unit 191, the data formulation unit 193 generates the map image 201 including the route 212 by referring to the map DB 192, and inputs it to the image rendering unit 194. The map image 201 is assumed to be an image displayed on a single screen and may be image data having a raster form, or may be image data having a vector form. The image rendering unit 194 corresponds to the image-rendering device shown in Embodiment 5. The image rendering unit 194 calculates alpha channel values by taking the route 212 as the base line. The image rendering unit 194 renders the output image 211 by alpha-blending the map image 201 and the car navigation background image, and outputs it to the display unit 195. In addition to the output image 211, the display unit 195 concurrently displays the time, a menu, etc. on the car navigation screen.

In conventional car navigation devices, there is a device of displaying an output image 221 to which a gradation effect is always applied by taking the screen center as the base line.

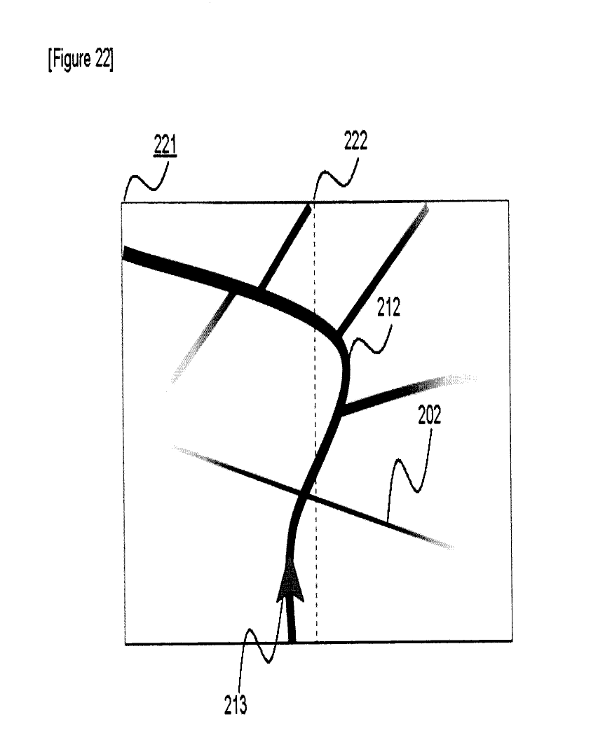

FIG. 22 is a diagram showing the output image 221 displayed on a conventional car navigation screen. A base line 222 is a vertical dotted line at the image center. While the base line 222 is not displayed on an actual car navigation screen, the base line 222 is specified here for convenience of explanation. The route 212 and roads adjacent to the base line 222 are displayed in black, and the color of road 202 changes from black to white being a background color as moving away from the base line 222.

However, the route is not always displayed at the screen center. Especially when the route bends, gradation is also applied to roads connected to the route and facilities around the route, etc., and there has been a problem that a user cannot easily recognize the neighborhood of route. On the other hand, since gradation is applied so as to follow the route in the car navigation device in the present embodiment, a user can easily recognize the route and the neighborhood thereof.

Since the screen center is always employed as the base line in a conventional car navigation device, alpha channel values for a displayed map can be used as those for another displayed map. However, if the route is employed as the base line, a route shape displayed on the screen changes as the vehicle travels, and the same alpha channel values cannot be used. Thus, the image rendering unit 194 needs to calculate alpha channel values in accordance with the route shape change and to perform processing of alpha-blending the map image and background. If a minimum distance from the route is calculated on a pixel-by-pixel basis, it takes time and it may happen that the image cannot be displayed in time. However, if the number of times for calculating the minimum distance from the base line is reduced by using a DB, an image to which a gradation effect is applied can be rendered at high speed.

While an example of applying the image-rendering device to a car navigation device in the present embodiment, the image-rendering device can be applied to not only car navigation devices but also any navigation devices in which a route is displayed on a map.

In the present embodiment, the route search unit 191 searches the route 212 on the basis of the current vehicle position, destination, and map DB 192; the data formulation unit 193 outputs a base line and a map image on the basis of the route 212 and map DB 192; a large region whose minimum configuration unit is an element is divided into small regions each configured with the elements by the image rendering unit 194; low resolution distance data showing a minimum distance from the base line is calculated for each of the small regions thereby; low resolution distance data for storing each minimum distance from the base line for each of the small regions is associated with high resolution distance data for storing each minimum distance from the base line for each of the elements and they are stored in the high resolution data DB 14 thereby; high resolution distance data that is associated with low resolution distance data, from among the low resolution distance data stored in the high resolution data DB 14, which coincides with the calculated low resolution distance data is obtained from the high resolution data DB 14 thereby; an alpha channel value is calculated on the basis of the high resolution distance data thereby; an image in which the map image and a background image are alpha-blended is rendered thereby; and the display unit 195 displays the image on a screen. Therefore, since gradation is applied centering around the route 212, an image having high visibility can be displayed.

### Embodiment 7

While gradation is rendered on the basis of low resolution distance data showing a minimum distance from a base line, or a gradation effect is applied to a route guide display screen of a car navigation device in Embodiments 1 through 6 above, an embodiment in which a minimum distance from a base point is set for each small region as low resolution data will be shown in the present embodiment.

Note that, in addition to include all components described in Embodiment 1 as shown in FIG. 1, further additional components are added and will be explained in the present embodiment.

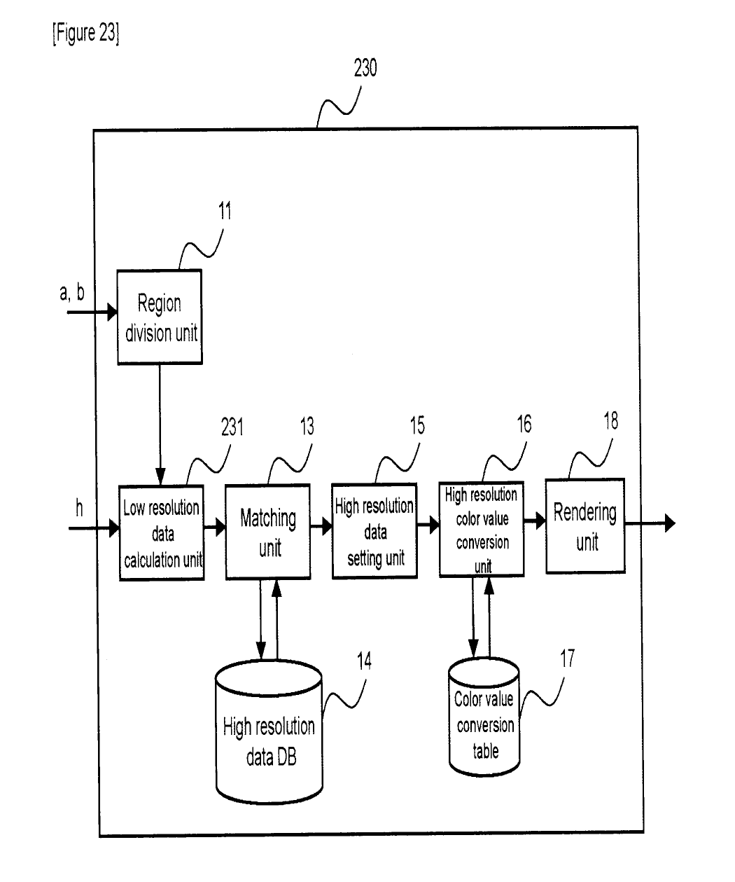

FIG. 23 is a block diagram showing a configuration of an image-rendering device 230 according to Embodiment 7.

A base line of a base point is inputted to a low resolution data calculation unit 231. The base point is a point serving as a reference for color change in gradation. The low resolution data calculation unit 231 calculates low resolution distance data showing a minimum distance from the base line or base point for each small region, and outputs it to the matching unit 13. In the present embodiment, a case will be explained in which a base point is inputted to the low resolution data calculation unit 231.

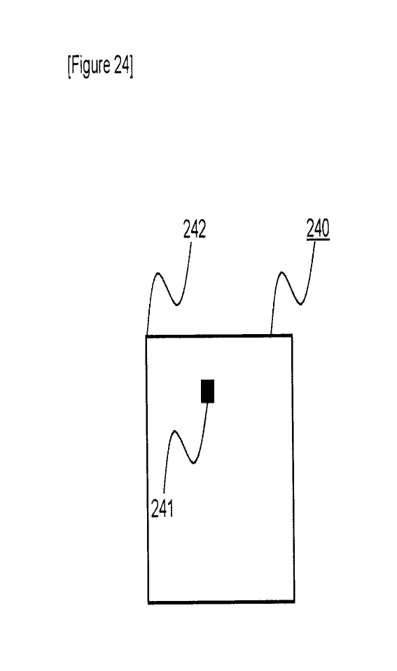

FIG. 24 is a diagram showing a base point 241 according to Embodiment 7. An image 240 is an image including the base point 241. An image size of the image 240 is the same with an image size of an image rendered by the image-rendering device 230. In the image 240, a coordinate of an upper left corner 242 is employed as an origin (0, 0), and the right direction and the lower direction are respectively defined as the +x-axis direction and the +y-axis direction. The base point 241 has a coordinate (60, 45). While the base point 241 is expressed by an absolute coordinate in FIG. 24, a data format of the base point is not limited particularly. The base point may be expressed by a relative coordinate, a polar coordinate, or the like, not just by the absolute coordinate.

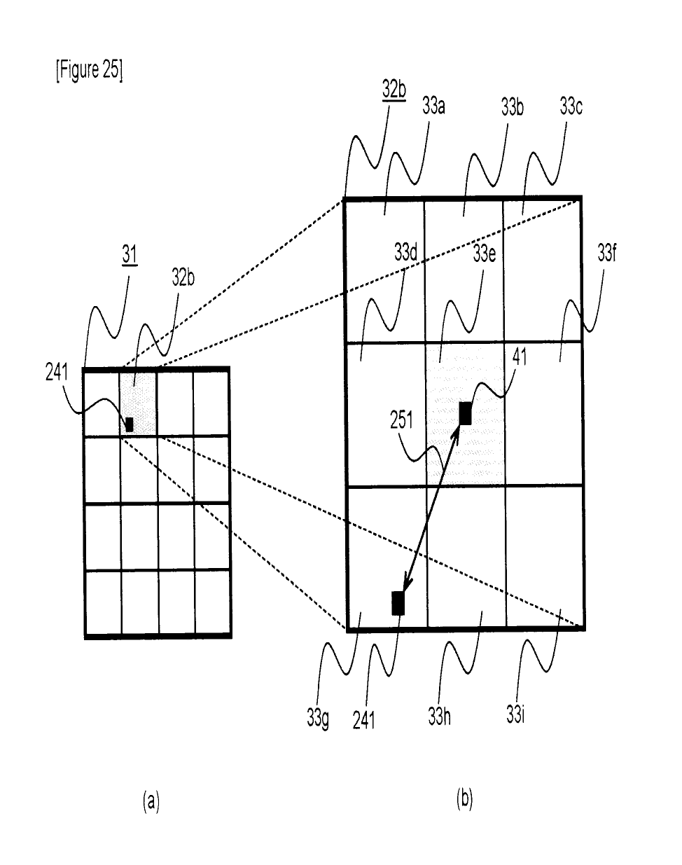

FIG. 25 is a diagram showing a minimum distance between the base point 241 and a small region 33e according to Embodiment 7. (a) in FIG. 25 is a diagram when the base point 241 included in the image 240 is rendered on the large region 31. The large region 31 is divided into 4×4 medium regions in height and width. (b) in FIG. 25 is an enlarged diagram of a medium region 32b. The medium region 32b is divided into 3×3 small regions 33a through 33i in height and width. The base point 241 shown in FIG. 24 is included in the small region 33g. The minimum distance between the base point 241 and the small region 33e is a minimum distance 251 between the base point 241 and a center point 41 of the small region 33e.

The low resolution data calculation unit 231 in FIG. 23 calculates the minimum distance 251 from the center point 41 of small region 33e to the base point 241 in FIG. 25. A method for calculating the minimum distance is not particularly limited in the present invention. For example, when the center point 41 of small region 33e is (x₀, y₀) and the base point 241 is (x₁, y₁), the minimum distance 251 can be calculated by the formula (7).

[Math. 7]

D=\sqrt{|x₁−x₀|²+|y₁−y₀|²} (7)

Note that, while the low resolution data calculation unit 231 calculates a minimum distance from the center point 41 of small region 33e to the base point 241 as the minimum distance between the base point 241 and small region 33e, a distance to the base point 241 from a corner of the small region 33e or another point in the small region 33e may be calculated as the minimum distance. Also, the low resolution data calculation unit 231 may calculate each minimum distance to the base point 241 from each of four corners configuring the small region 33e, and an average of the minimum distances may be calculated. Here, the low resolution data calculation unit 231 should employ the same calculation method for all small regions.

In addition, the low resolution data calculation unit 231 in FIG. 23 may calculate each minimum distance to the base point 241 from each of four corners configuring the medium region 32b and a minimum distance to the base point 241 from a center point of the medium region 32b in FIG. 25, and a minimum distance value to the base point 241 for each of the small regions 33a through 33i may be calculated by using values of the foregoing minimum distances. Note that, not just the four corners configuring the medium region 32b and the center point thereof, the low resolution data calculation unit 231 may calculate a minimum distance value to the base point 241 for each of the small regions 33a through 33i by using values obtained from minimum distances from other points to the base point 241.

In FIG. 23, the low resolution data calculation unit 231 calculates a minimum distance from the base point 241 for each of all small regions included in the large region 31 in FIG. 25, sets each distance to each of the small regions, and outputs them to the matching unit 13. The matching unit 13 accesses the high resolution data DB 14, conducts search by employing the low resolution distance data inputted from the low resolution data calculation unit 231 as a key, obtains the high resolution distance data, and outputs it to the high resolution data setting unit 15. The high resolution data setting unit 15 sets the high resolution distance data at each medium region in the large region, and outputs it to the high resolution color value conversion unit 16.

If a size of the high resolution distance data does not coincide with the medium region, the high resolution data setting unit 15 expands or compresses the high resolution distance data and sets it in accordance with a size of each medium region. A method for expanding or compressing the high resolution distance data is not particularly designated. For example, a Nearest Neighbor method or a bilinear interpolation method may be employed. The subsequent processing is the same with that in Embodiment 1.

Note that the image-rendering device 230 may set a color value in accordance with a minimum distance from the base point for each small region as the low resolution data.

The image-rendering device 230 may set a minimum distance value as the low resolution data, and may render gradation by converting the distance value into a blend ratio and converting the blend ratio into a color value.

The image-rendering device 230 may calculate the high resolution data from the low resolution data by employing algorithm, without using the high resolution data DB.

The image-rendering device 230 may calculate an alpha channel value on the basis of high resolution distance data associated with the low resolution data in which a minimum distance from the base point is set for each small region, and may apply a gradation effect to an image by alpha-blending a foreground image and a background image.

The image-rendering device 230 may calculate an alpha channel value on the basis of high resolution distance data associated with the low resolution data in which a minimum distance from the base point is set for each small region, and may apply a gradation effect to an image by alpha-blending a foreground image and a background image. It may be employed in a case where a gradation effect is applied to a route guide display screen of a navigation device.

In the present embodiment, a large region whose minimum configuration unit is an element is divided into small regions each configured with the elements; low resolution distance data showing a minimum distance from a base line or a base point serving as a reference for color change in gradation is calculated for each of the small regions; the low resolution distance data for storing each minimum distance from the base line or base point for each of the small regions is associated with high resolution distance data for storing each minimum distance from the base line or base point for each of the elements and they are stored in the high resolution data DB 14; high resolution distance data associated with low resolution distance data, from among the low resolution distance data stored in the high resolution data DB 14, which coincides with the calculated low resolution distance data is obtained from the high resolution data DB 14; the obtained high resolution distance data is converted into high resolution color value data for storing color values for the elements; and gradation is rendered on the basis of the converted high resolution color value data. Therefore, since it is not necessary to calculate the minimum distance from the base line or base point for all pixels, the number of times for calculating the minimum distance can be reduced.

### Embodiment 8

While a minimum distance from a base line or a base point is set for each small region as low resolution data in Embodiments 7 above, an embodiment of setting, as high resolution data, texture to which a gradation effect is applied will be shown in the present embodiment.

Texture is image data. Texture is used when a three-dimensional image is rendered by texture mapping. Texture mapping is a method of rendering a three-dimensional image by expressing an object by a combination of polygons and by pasting texture on the polygons. Texture mapping can render a three-dimensional image with texture at a small amount of processing.

Note that, since the region division unit 11 and low resolution data calculation unit 231 in Embodiment 8 are the same with those in Embodiment 7, their description will be omitted.

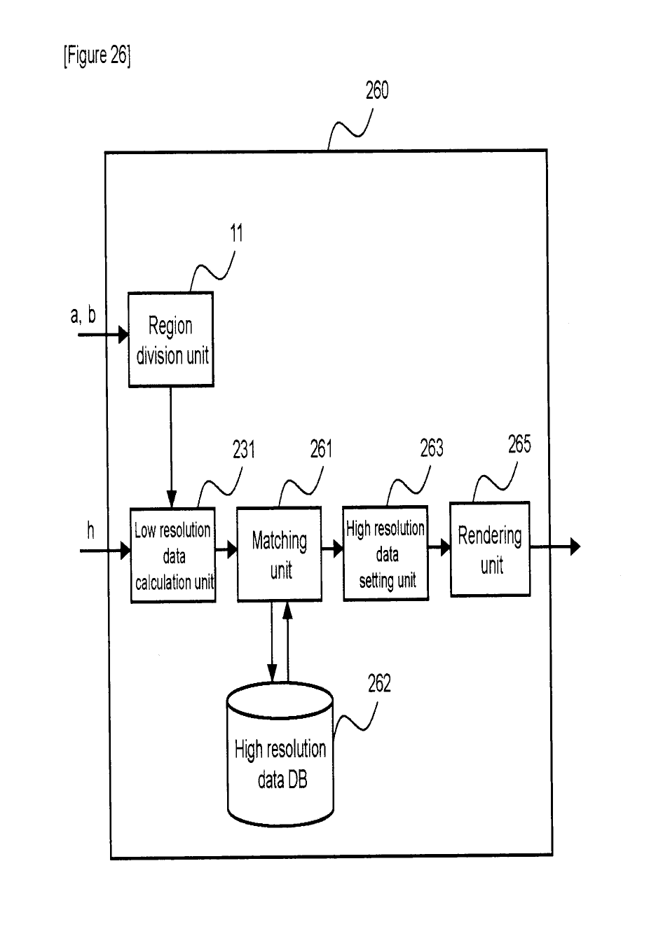

FIG. 26 is a block diagram showing a configuration of an image-rendering device 260 according to Embodiment 8.

The low resolution data calculation unit 231 calculates low resolution distance data showing a minimum distance from the base line or base point for each small region, and outputs it to a matching unit 261. In a high resolution data DB 262, high resolution texture data is stored as high resolution data associated with the low resolution distance data.

The matching unit 261 accesses the high resolution data DB 262, and conducts search by employing the low resolution distance data inputted from the low resolution data calculation unit 231 as a key. The matching unit 261 obtains the high resolution texture data associated with the low resolution distance data, and outputs it to a high resolution data setting unit 263. The high resolution data setting unit 263 sets the high resolution texture data at each medium region in the large region. If a size of the high resolution texture data does not coincide with the medium region, the high resolution data setting unit 263 expands or compresses the high resolution texture data sets it in accordance with a size of each medium region, and outputs it to a rendering unit 264. The rendering unit 264 renders an image and outputs it.

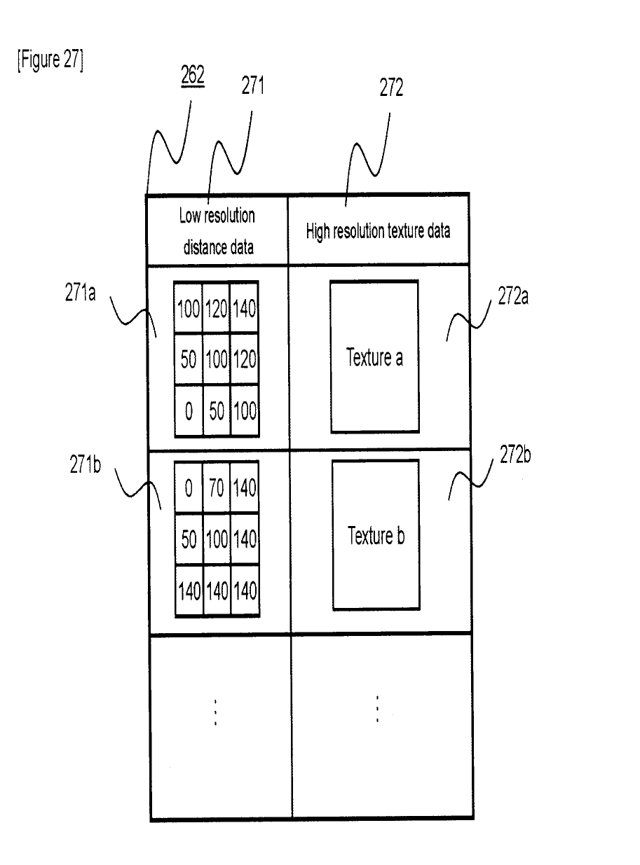

FIG. 27 is a diagram showing data stored in the high resolution data DB 262 according to Embodiment 8. Low resolution distance data 271 and high resolution texture data 272 are stored in the high resolution data DB 262. While a minimum distance value from the base line or base point is set for each of the small regions in the low resolution distance data 271, texture serving as image data is set in the high resolution texture data 272.

High resolution texture data 272a is high resolution texture data associated with low resolution distance data 271a. In the low resolution distance data 271a, minimum distance values each set for the respective small regions increase from 0 to 140 as moving from the lower left toward the upper right. The high resolution texture data 272a is an image in which color values each set for the respective elements change from white to black as moving from the lower left toward the upper right, and is texture a.

High resolution texture data 272b is high resolution texture data associated with low resolution distance data 271b. In the low resolution texture data 271b, minimum distance values each set for the respective small regions increase from 0 to 140 as moving from the upper left toward the lower right. The high resolution texture data 272b is an image in which color values each set for the respective elements change from white to black as moving from the upper left toward the lower right, and is texture b. While two pieces of data are shown as an example here, the low resolution distance data having various patterns is associated with the high resolution texture data and they are stored in the high resolution data DB 262 actually.

The high resolution data DB 262 calculates in advance an evaluation value K and a gravity center G for each of the low resolution distance data 271a and 271b. The matching unit 261 calculates the evaluation value K and gravity center G for the low resolution distance data inputted from the low resolution data calculation unit 231. The matching unit 13 searches the high resolution data DB 262 by employing the evaluation value K of low resolution distance data 271 as a key, and outputs the associated high resolution texture data to the high resolution data setting unit 263.

If a size of the high resolution texture data does not coincide with the medium region, the high resolution data setting unit 263 expands or compresses the high resolution texture data and sets it in accordance with a size of each medium region. A method for expanding or compressing the high resolution texture data is not particularly designated. For example, a Nearest Neighbor method or a bilinear interpolation method may be employed.

In the present embodiment, a large region whose minimum configuration unit is an element is divided into small regions each configured with the elements; low resolution distance data showing a minimum distance from a base line or a base point serving as a reference for color change in gradation is calculated for each of the small regions; low resolution distance data for storing each minimum distance from the base line or base point for each of the small regions is associated with high resolution texture data for storing each minimum distance from the base line or base point for each of the elements and they are stored in the high resolution data DB 262; high resolution texture data that is associated with low resolution distance data, from among the low resolution distance data stored in the high resolution data DB 262, which coincides with the calculated low resolution distance data is obtained from the high resolution data DB 262; and gradation is rendered on the basis of the obtained high resolution texture data. Therefore, since it is not necessary to calculate the minimum distance from the base line or base point for all pixels, the number of times for calculating the minimum distance can be reduced.

### REFERENCE NUMERALS

10, 100, 150, 160, 230, 260 image-rendering device; 11 region division unit; 12, 231 low resolution data calculation unit; 13, 103, 261 matching unit; 14, 104 262 high resolution data DB; 15, 105, 151, 263 high resolution data setting unit; 16, 143 high resolution color value conversion unit; 17, 102, 144 color value conversion table; 18, 161, 264 rendering unit; 20, 181, 240 image; 21, 173, 222 base line; 22, 23a-d, 242 corner; 31, 91, 92 large region; 32, 32b medium region; 33, 33a-i, 82a-i small region; 34 element; 41 center point of small region 33e; 42 minimum distance from base line 21 to center point 41 of small region 33e; 51, 61, 61a′-b, 61e, 271, 271a-b low resolution distance data; 62, 62a-e high resolution distance data; 101 low resolution color value conversion unit; 111, 121, 121a-b low resolution color value data; 122, 122a-b high resolution color value data; 141 high resolution blend ratio conversion unit; 142 blend ratio conversion table; 171 foreground image; 172 background image; 211, 221 output image; 191 route search unit; 192 map DB; 193 data formulation unit; 194 image rendering unit; 195 display unit; 201 map image; 202 road; 212 route; 213 arrow; 241 base point; 251 minimum distance from base point 241 to center point 41 of small region 33e; and 272, 272a-b high resolution texture data.

1-21. (canceled)

22. An image-rendering device comprising:
a region divider that divides a large region whose minimum configuration unit is an element into small regions each configured with the elements;
a low resolution data calculator that calculates low resolution distance data showing a distance from a base line serving as a reference for color change in gradation, to each of the small regions;
a high resolution data storage that stores the low resolution distance data and high resolution distance data showing each distance from the base line to each of the elements, the low resolution distance data being associated with the high resolution distance data;
a matching processor that obtains, from the high resolution data storage, the high resolution distance data associated with the low resolution distance data calculated by the low resolution data calculator, from the high resolution data storage; and
a rendering processor that renders gradation on the basis of the high resolution distance data.

23. The image-rendering device in claim 22, further comprising
a high resolution color value convertor unit that converts the high resolution distance data obtained from the matching processor into high resolution color value data showing a color value for each of the elements, wherein
the rendering processor renders gradation on the basis of the high resolution color value data.

24. The image-rendering device in claim 23, further comprising:
a high resolution blend ratio convertor that converts the high resolution distance data obtained from the matching processor into high resolution blend ratio data showing a blend ratio which shows a color value mix ratio for each of the elements, wherein
the high resolution color value convertor converts the high resolution blend ratio data into the high resolution color value data.

25. The image-rendering device in claim 22, wherein the rendering processor calculates an alpha channel value on the basis of the high resolution distance data, and renders an image in which a foreground image and a background image are alpha-blended.

26. An image-rendering device comprising:
a high resolution data calculator that calculates, from low resolution distance data showing a distance from a base line serving as a reference for color change in gradation to each of small regions having elements each being a minimum configuration unit, high resolution distance data showing a distance from the base line to each of the elements; and
a rendering processor that calculates an alpha channel value on the basis of the high resolution distance data, and renders an image in which a foreground image and a background image are alpha-blended.

27. A navigation device comprising:
a route search engine that searches a route on the basis of a current vehicle position, a destination, and a map database;
a data generator that generates a map image on the basis of the route and the map database, and outputs a base line serving as a reference for color change in gradation and the map image;
a high resolution data calculator that calculates, from low resolution distance data showing a distance from the base line to each of small regions having elements each being a minimum configuration unit, high resolution distance data showing a distance from the base line to each of the elements; and
an image rendering processor that calculates an alpha channel value on the basis of the high resolution distance data, and renders an image in which the map image and a background image are alpha-blended.

28. An image-rendering device comprising:
a region divider unit that divides a large region whose minimum configuration unit is an element into small regions each configured with the elements;
a low resolution data calculator unit that calculates low resolution distance data showing a distance from a base point serving as a reference for color change in gradation, to each of the small regions;
a high resolution data storage that stores the low resolution distance data and high resolution distance data showing each distance from the base point to each of the elements, the low resolution distance data being associated with the high resolution distance data;
a matching processor that obtains, from the high resolution data storage, the high resolution distance data associated with the low resolution distance data calculated by the low resolution data calculator; and
a rendering processor that renders gradation on the basis of the high resolution distance data.

29. The image-rendering device in claim 28, further comprising:
a high resolution color value convertor that converts the high resolution distance data obtained from the matching processor into high resolution color value data showing a color value for each of the elements, wherein
the rendering processor renders gradation on the basis of the high resolution color value data.

30. The image-rendering device in claim 29, further comprising:
a high resolution blend ratio convertor that converts the high resolution distance data obtained from the matching processor into high resolution blend ratio data showing a blend ratio which shows a color value mix ratio for each of the elements, wherein
the high resolution color value convertor converts the high resolution blend ratio data into the high resolution color value data.

31. The image-rendering device in claim 28, wherein the rendering processor calculates an alpha channel value on the basis of the high resolution distance data, and renders an image in which a foreground image and a background image are alpha-blended.

32. An image-rendering device comprising:
a high resolution data petting calculator that calculates, from low resolution distance data showing a distance from a base point serving as a reference for color change in gradation to each of small regions having elements each being a minimum configuration unit, high resolution distance data showing a distance from the base point to each of the elements; and
a rendering processor that calculates an alpha channel value on the basis of the high resolution distance data, and renders an image in which a foreground image and a background image are alpha-blended.
